(19) United States
(12) Patent Application Publication
(10) Pub. No.: US 2025/0338789 A1
(43) Pub. Date: Nov. 6, 2025

(54) SEEDLING MACHINE AND METHODS OF USE THEREOF

(71) Applicant: Freight Farms, Inc., Boston, MA (US)

(72) Inventors: Alexander ALLARDI, Boston, MA (US); Jacob FELSER, Boston, MA (US)

(21) Appl. No.: 19/126,549

(22) PCT Filed: Nov. 2, 2023
(86) PCT No.: PCT/US2023/078456

§ 371 Date: May 1, 2025

Related U.S. Application Data
(60) Provisional application No. 63/381,995, filed on Nov. 2, 2022.

(51) Int. Cl. A01C 1/02; A01G 7/04; A01G 9/02; A01G 9/029; A01G 27/00; G05B 19/4155

(52) U.S. Cl. CPC A01C 1/02; A01G 7/045; A01G 9/023; A01G 9/029; A01G 27/003; A01G 27/005; G05B 19/4155; G05B 2219/45017

(57) ABSTRACT

Systems and methods for operating a seedling germination and maturation system including a reservoir, a pump in fluid communication with the reservoir, a plurality of shelves, and a controller. Each of the plurality of shelves includes: raised side walls configured to form an irrigation trough configured to receive a plurality of seeded trays, a supply valve in fluid communication with the irrigation trough and a pump outlet, a drain valve in fluid communication with the irrigation trough and the reservoir. The controller is configured to actuate the pump and, for a particular shelf of the plurality of shelves, acuate the particular fill valve and the particular drain valve of the particular shelf, to control an irrigation cycle for each particular shelf of the plurality of shelves. The irrigation cycle for each particular shelf is controlled independently of the irrigation cycles for other shelves of the plurality of shelves.

### CROSS-REFERENCE TO RELATED APPLICATION

This application claims the benefit of U.S. Provisional Application No. 63/381,995, entitled “SEEDLING MACHINE AND METHODS OF USE THEREOF” filed Nov. 2, 2022, and hereby incorporates by reference herein the entire contents of this priority application.

### FIELD OF THE TECHNOLOGY

Aspects of the present disclosure relate to agricultural growing systems and, in particular, to modular container farming.

### BACKGROUND

The need for fresh food is growing as the population increases and climate changes impact crop growing seasons. The current food supply model, based on traditional farming methods and long distance shipping, is economically and environmentally unsustainable. Traditional farming operations are usually located in agricultural areas, which require large upfront costs, large acreage and have high operational costs from seed to sale. Therefore, there is a need for efficient farming systems and methods, and improvements thereto.

Urban and local agriculture face obstacles in providing space for growing plants. Space for farming is limited in cities and rarely sufficient to meet a high demand. High start-up and operating costs of greenhouses make local crop production difficult. Structures intended to support rooftop greenhouses, for example, must be evaluated by structural engineers and often require additional bracing to support the extra weight. Urban gardens often must address contaminated soil. Hydroponic systems are not easily used in urban locales, as most hydroponic systems are meant to be installed in agricultural settings, are not easily transportable, and require extensive training of personnel for operation. Thus, self-contained agricultural systems have recently been developed for generating high-yield crops. Such self-contained systems may be located in unused buildings, such as warehouses, or in specialized or repurposed closed or semi-closed environments and often utilize vertically oriented plant arrangements.

### SUMMARY

In one example approach, such systems may be contained within a modular container or other farm housing, which may be mobile (e.g., can be moved from a first location to a second location), and may include a growing system that includes various features to support agricultural production, such as a seeding machine to plant seeds, a seedling and germination system to support (e.g., supply nutrients, water, and light to) the seeds as they germinate and the germinated seedlings as they grow, and a packaging system configured to package mature seedlings for shipment to a customer. The seedling germination and maturation system includes a plurality of shelves to hold the growing seedlings, a lighting system to provide appropriate light for the plants, an irrigation system to provide nutrients to the plants, a climate control system to control the environmental conditions within the container, a ventilation system for providing airflow to the plants, and a system to monitor and control the components of the growing system.

In some aspects, such systems may include a reservoir, a pump in fluid communication with the reservoir, a plurality of shelves, and the controller. Each of the plurality of shelves includes raised side walls configured to form an irrigation trough configured to receive a plurality of seeded trays, a supply valve in fluid communication with the irrigation trough and a pump outlet, and a drain valve in fluid communication with the irrigation trough and the reservoir. The controller is configured to actuate the pump and, for a particular shelf of the plurality of shelves, acuate the particular fill valve and the particular drain valve of the particular shelf, to control an irrigation cycle for each particular shelf of the plurality of shelves. The irrigation cycle for each particular shelf may be controlled independently of the irrigation cycles for other shelves of the plurality of shelves.

In some aspects, such systems may include a seedling production system including a seedling germination and maturation system. The seedling germination and maturation system may include a plurality of shelves configured to receive a plurality of seeded trays therein. Each of the plurality of shelves may include a seedling germination portion and a seedling maturation portion. The seedling germination portion may be configured to receive a plurality of seeded trays at least until a determination has been made that germination has occurred. The seedling germination portion may include a plurality of walls couplable to each of the plurality of shelves to form a germination volume and maintain the germination volume at a target humidity range. The seedling maturation portion may be configured to receive the plurality of seeded trays for a maturation period after the plurality of seeded trays have exited the seedling germination portion.

In some aspects, a computer-implemented method for providing one or more seedlings to a farm may include receiving captured image data of one or more seeded trays positioned in a germination portion of a seedling germination and maturation system; determining, based on the captured image data, that germination has occurred in the one or more seeded trays; and increasing an amount of light provided to the one or more seeded trays in response to determining that germination has occurred.

Examples of various such features are shown and described with respect to U.S. Pat. No. 10,271,486 entitled Insulated Shipping Containers Modified for High-Yield Plant Production Capable in Any Environment, issued Apr. 30, 2019; U.S. Pat. No. 11,026,380 entitled Vertical Assembly for Growing Plants, Jun. 8, 2021; U.S. Pat. No. 10,785,925 entitled Insulated Shipping Containers Modified for High-Yield Fungi Production Capable in Any Environment, issued Sep. 29, 2020; U.S. Patent Publication No. 2019/0133026 entitled Modular Farm Control and Monitoring System, published May 9, 2019; U.S. Patent Publication No. 2020/0037524 entitled Modular Farm with Carousel System, published Feb. 6, 2020; and U.S. Patent Publication No. 2020/0359569 entitled Hub and Spoke Modular Farm System, published Nov. 19, 2020, each of the foregoing of which is hereby incorporated herein by reference in its entirety.

Additional advantages and novel features of these aspects will be set forth in part in the description that follows, and in part will become more apparent to those skilled in the art upon examination of the following upon learning by practice of the disclosure.

### BRIEF DESCRIPTION OF THE FIGURES

FIG. 1 illustrates a schematic representation of an example system configured for planting, germinating, and growing plant seedlings in accordance with various features of the present disclosure.

FIG. 2 illustrates a perspective view of an example seedling germination and maturation system of the system of FIG. 1, in accordance with various features of the present disclosure.

FIG. 3 illustrates an example of a cart for use with the seedling germination and maturation system of FIG. 2, in accordance with various features of the present disclosure.

FIG. 4 illustrates a side view of an example of a cart for use with a seedling germination and maturation system of FIG. 2, in accordance with various features of the present disclosure.

FIG. 5 illustrates a detail view of an example germination portion of the seedling machine of FIG. 3, in accordance with various features of the present disclosure.

FIG. 6 illustrates another detail view of an example germination portion of the seedling machine of FIG. 3, in accordance with various features of the present disclosure.

FIG. 6A illustrates a detail view of an example germination portion of the seedling machine of FIG. 3, in accordance with various features of the present disclosure.

FIG. 7 illustrates a schematic representation of an example reservoir and an example nutrient dosing and monitoring system in accordance with various features of the present disclosure.

FIG. 8 illustrates a perspective view of another example seedling germination and maturation system of the system of FIG. 1, in accordance with various features of the present disclosure.

FIG. 9 illustrates a detailed view of an example germination portion of the seedling machine of FIG. 8, in accordance with various features of the present disclosure.

FIG. 10 illustrates another schematic representation of an example reservoir and an example nutrient dosing and monitoring system in accordance with various features of the present disclosure.

FIG. 11 illustrates an example reservoir and an example nutrient dosing and monitoring system in accordance with various features of the present disclosure.

FIGS. 12A-8C illustrate an example method for providing seedlings to a user in accordance with various features of the present disclosure.

FIG. 14 shows an example system diagram of various hardware components and other features for use with the system of FIG. 1, according to aspects of the present disclosure.

FIG. 15 shows a representative block diagram of various example system components for use with the farm container of FIG. 1, according to aspects of the present disclosure.

### DETAILED DESCRIPTION

Aspects of the present disclosure relate to improvements and/or enhancements to various features of an agricultural growing system, including, but not limited to a seeding system, a seedling germination and maturation system, and a seedling packaging system, for a farm container or other type of hydroponic growing system that that may provide plant seedlings for delivery to a user of on an on-demand basis, as well as other benefits.

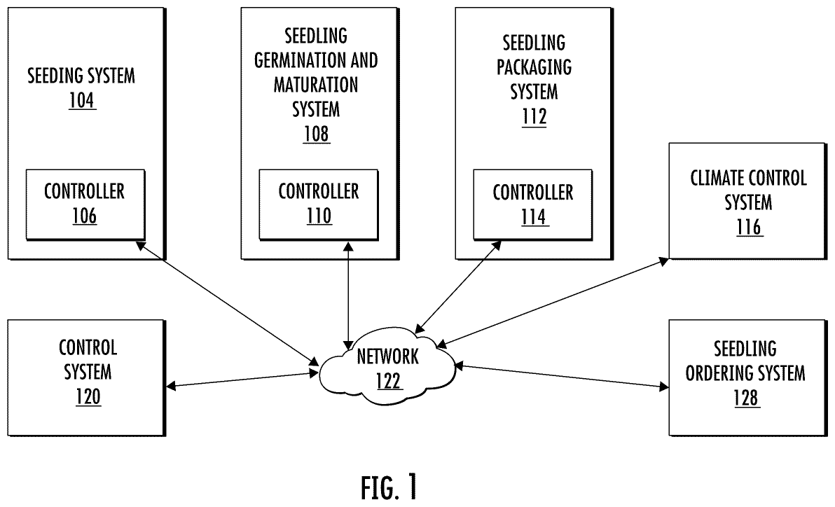

FIG. 1 illustrates a schematic representation of an example system 100 that may be configured for planting, germinating, and growing plant seedlings in accordance with some aspects of the present disclosure. In some aspects, the system 100 may include a seeding system 104, a seedling germination and maturation system 108, 800, a seedling packaging system 112, a climate control system 116, and a control system 120. In some aspects, the system 100 may include the seedling germination and maturation system 108. The plant seedlings may grow in the system 100 until the plant seedlings are mature enough to be shipped to customers or transplanted into a hydroponic growing system located near the system 100. In some aspects, the system 100 may comprise a self-contained system in which plant seedling plugs configured for hydroponic growth are produced for transplantation in hydroponic growing system. In some aspects, the system 100 may be disposed in a farm container and coupled to a hub container, such as the system described in U.S. Patent Publication No. 2020/0359569, which is incorporated by reference herein in its entirety. In such aspects, one or more of the containers coupled to the hub container include the system 100 and one or more containers are farm containers as described in U.S. Patent Publication No. 2020/0359569 and are specialized in the hydroponic growth of seedlings into mature plants that can be harvested. In such aspects, the container including the system 100 may have electrical systems, climate control systems (e.g., heating, ventilation, air conditioning system), humidity management, carbon dioxide level control, and ventilation systems described in U.S. Patent Publication No. 2020/0359569. In such variants, these systems may be managed by the control system 120 or by a farm management system. In other aspects, the system 100 may be deployed in a greenhouse, warehouse, or other structure.

In some aspects, the seeding system 104 may have a controller 120 configured to control operations of the seeding system 104, the seedling germination and maturation system 108 may have a controller 106 configured to control operations of the seedling germination and maturation system 108, and the seedling packaging system 112 may have a controller 114 configured to control operations of the seedling packaging system 112. The control system 120 may be interchangeably referred to herein as the controller 120. Components of the seeding system 104, the seedling germination and maturation system 108, 800 the seedling packaging system 112, the climate control system 116, the control system 120, and the seedling ordering system 128 are all configured to communicate over a network 122. The processes described herein are described with respect to the control system 120. However, it should be understood that the controllers 106, 110, 114 can also conduct the processes described herein as related to the seeding system 104, seedling germination and maturation system 108, and seedling packaging system 112, respectively. In some aspects, the processes described herein as related to the controllers 106, 110, 114, the climate control system 116, and the control system 120 may be enacted by a single controller. In some aspects, the control system 120 may be remotely located from the seedling germination and maturation system 108, 800. In some aspects, the control system 120 may control two or more seeding germination and maturation systems 108, 800. In some aspects, the control system 120 may be part of a larger farm management system. For example, in aspects in which the system 100 is used in a multi-container system, the control system 120 may be a part of a farm management system that manages operation of all of the container farms (e.g., both seedling containers and growing containers) in a particular farm or network of farms.

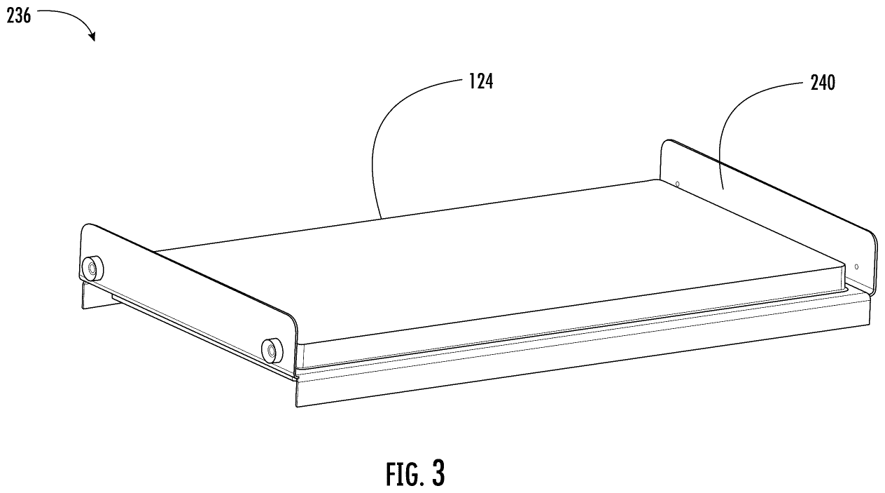

In some aspects, the seeding system 104 may be configured to plant seeds for a particular plant in a tray 124 (FIG. 3). An example seeding system 104 may include the Seeder A-10-Seeder Machine by Visser Horti Systems of ′s-Gravendeel, the Netherlands. In some aspects, the seeding system 104 may be configured to communicate with a seedling ordering system 128 via a wireless or wired connection, such as, for example the seedling subscription system described in PCT Application No. PCT/US2023/066107 entitled “Modular Farm and Methods of Making and Use Thereof,” filed Apr. 24, 2023, which is hereby incorporated by reference herein. In other aspects, the seeding system 104 may be configured to communicate with the larger farm management system, as described above. The system 104 may receive an order from the farm management system or an operator of the farm management system. The seeding system 104 may receive an order including one or more desired varieties of seedlings. The seeding system 104 may be configured to generate a command to plant a particular number of a particular type of seed in a particular tray 124 based on the received order. The seeding system 104 may plant a tray 124 based on the command. In some aspects, the seeding system 104 may be configured to seed full trays 124. In such aspects, the order and the command may include a variety of seedlings to be planted in the tray 124. In some aspects, the command may include a density of seedling plugs to be planted in the tray 124. In some aspects, the seeding system 104 may be configured to seed partial trays 124. In such aspects, the order and the command may include a variety of seedlings and a number of seeds to be planted in the tray 124.

In other aspects, the system 100 may not include the seeding system 104. In such aspects, the trays 124 may be manually planted based on the received order.

The seeded tray 124 may then be transferred to the seedling germination and maturation system 108. In some aspects, transfer to the seedling germination and maturation system 108 may be automated. In some aspects, an operator may transfer the seeded tray 124 to the seedling germination and maturation system 108.

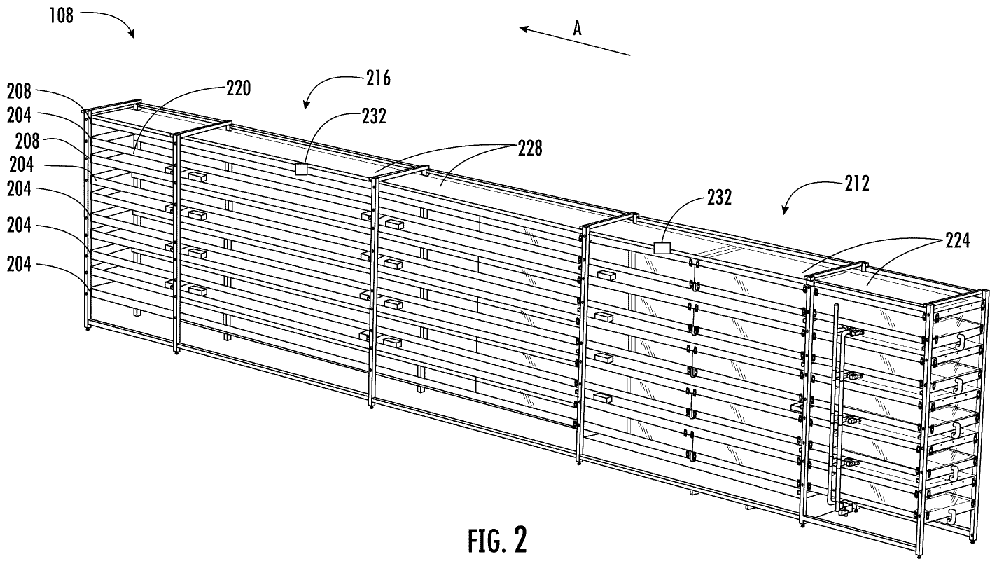

FIG. 2 illustrates a perspective view of an example seedling germination and maturation system 108 according to aspects of the present disclosure. The seedling germination and maturation system 108 may include a plurality of shelves 204 and a plurality of panels 208. Each of the shelves 204 may include a first or germination portion 212 and a second or maturation portion 216. The germination portion 212 may be configured to receive trays 124 that contain seeds and maintain the trays 124 at least until the seeds have germinated. The maturation portion 216 is configured to receive trays 124 of germinated seeds and maintain the trays 124 as the seedlings mature.

The shelves 204 may be substantially tray-shaped (e.g., have raised sides 220) so that the shelves 204 may each form an irrigation trough configured to hold a mixture of water and nutrients therein. Each of the panels 208 may include a first plurality of lights 224 configured to provide light to the germination portion 212 and a second plurality of lights 228 configured to provide light to the maturation portion 216. Each panel 208 may be positioned above a corresponding shelf 204, such that the plurality of lights 224, 228 can provide light to plants growing on the corresponding shelf 204. The first plurality of lights 224 and the second plurality of lights 228 may be controlled by the control system 120 as described in greater detail below. In some aspects, the first plurality of lights 224 may be controlled independently from the second plurality of lights 228.

In some aspects, the panels 208 may include one or more cameras 232. In some aspects, the camera 232 may be a wide angle camera or an ultrawide angle camera. In some aspects, the cameras 232 may be configured to capture image data in the visual light spectrum, the infrared (IR) light spectrum, and/or both the visual light and IR light spectra. The one or more cameras 232 may be configured to capture images of the trays 124 and/or seedlings growing in the trays 124. For example, the cameras 232 may be coupled to the panels 208 facing the tray(s). In some aspects, cameras 232 may be mounted elsewhere. In some aspects, the cameras 232 may be configured to transmit the captured image data of the tray(s) and/or the seedlings to a display of a user input/output interface. In some aspects, the control system 120 may be configured to determine, based on the captured image data, that seedlings in a particular tray 124 have germinated, that the plant mass of seedlings in a particular tray 124 has increased, and/or that the seedlings in a particular tray 124 are mature and ready for transplantation. In some aspects, the control system 120 may be configured to alter a mixture of red and blue wavelengths of the light provided by the lights 224, 228 based on the captured image data to change the growth of the seedlings. For example, light having red wavelengths may cause the seedlings to grow tall and thin, and light having blue wavelengths may cause the seedlings to grow short and wide.

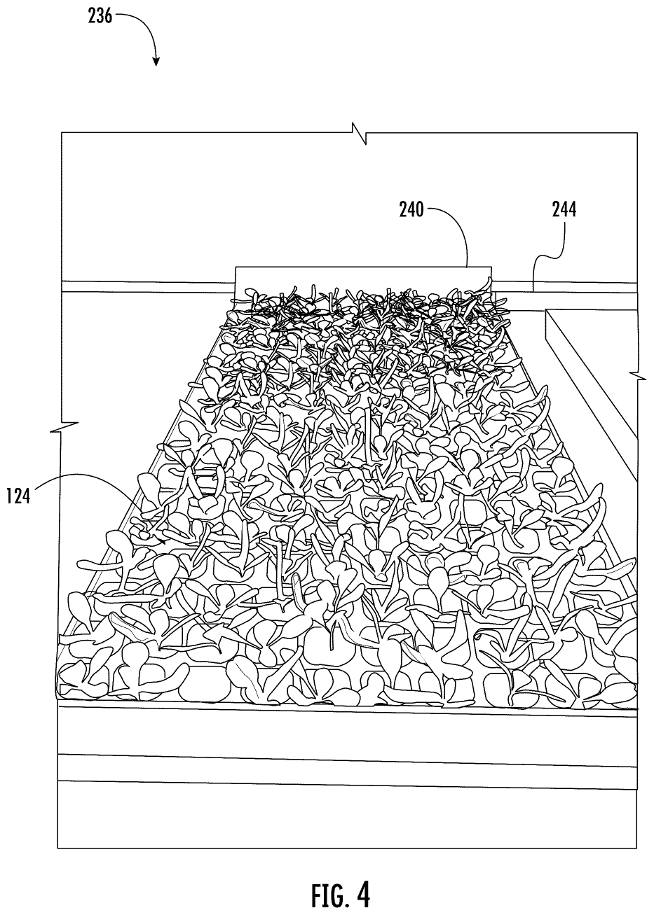

In the variant shown in FIG. 2, the seedling germination and maturation system 108 may include five shelves 204. In other aspects, the seedling germination and maturation system 108 may include more or fewer shelves 204. In some aspects, a spacing between adjacent shelves 204 may be customizable to accommodate trays of seedlings of different heights. Each of the shelves 204 may be configured to receive a plurality of wheeled carts 236 therein. As shown in FIGS. 3-4, the carts 236 may be configured to receive the seeded trays 124. As shown in FIGS. 3-4, the carts 236 may have sides 240 that extend above the height of the seeded trays 124. As shown in FIG. 4 and described in greater detail below, the sides 240 may protect seedlings as the carts 236 exit the germination portion 212. As shown in FIG. 4, the shelves 204 may include one or more rails 244 configured to guide the carts 236 as the carts 236 travel along the shelves in a direction illustrated by the arrow A (FIG. 2). The shelves 204 may be substantially similar to each other, so only the first shelf 204 is described in detail herein.

Seeded trays 124 may be placed on carts 236, and the tray 124 and cart 236 may enter the seedling germination and maturation system 108 via the germination portion 212. Although the following sections refer to trays 124, it is to be understood that each tray 124 may be coupled to a cart 236 and the tray 124 and cart 236 may move together through the seedling germination and maturation system. In some aspects, seeded trays 124 may be added to the germination portion 212 at predefined time intervals. The length of the predefined time intervals may be configured to allow each seeded tray 124 to remain in the germination portion 212 until the seedlings planted in the seeded tray 124 have germinated and begun to mature. The length of the predefined time intervals may be long enough that the seeded trays 124 remain in the seedling germination and maturation system 108 for a long enough time for the seedlings on the seeded trays 124 exiting the maturation portion 216 to be ready for shipment. The length of the predefined time intervals may vary based on a type of seedling being germinated and grown. In some aspects, upon expiration of the predefined time interval, the seedling germination and maturation system 108 may be configured to notify a user that it is time to insert a newly seeded tray 124 into the germination portion 212. For example, the seedling germination and maturation system 108 may send a notification to an operator via a web interface, to an application on an operator's smartphone, and so forth. In some aspects, upon expiration of the predefined time interval, the seedling germination and maturation system 108 may be configured to notify a user that it is time to harvest a seeded tray 124 from the maturation portion 216. In some aspects, the seeded trays 124 may be added to the germination portion 212 individually. In some aspects, multiple seeded trays 124 may be added to the germination portion 212 at the same time.

In some aspects, upon expiration of the predefined time interval, the seedling germination and maturation system 108 may be configured command a transfer device to retrieve a newly seeded tray 124 from the seeding system 104 and transfer the newly seeded tray 124 into the germination portion 212. In such aspects, the seeded tray 124 may be transferred from the seeding system 104 to the seedling germination and maturation system 108 without human intervention.

In some aspects, upon expiration of the predefined time interval, the seedling germination and maturation system 108 may be configured to command a transfer device to harvest a tray 124 of seedlings from the maturation portion 216 and transfer the tray 124 of seedlings to the seedling packaging system 112. In such aspects, the seeded tray 124 may be transferred from the seedling germination and maturation system 108 to the seedling packaging system 112 without human intervention.

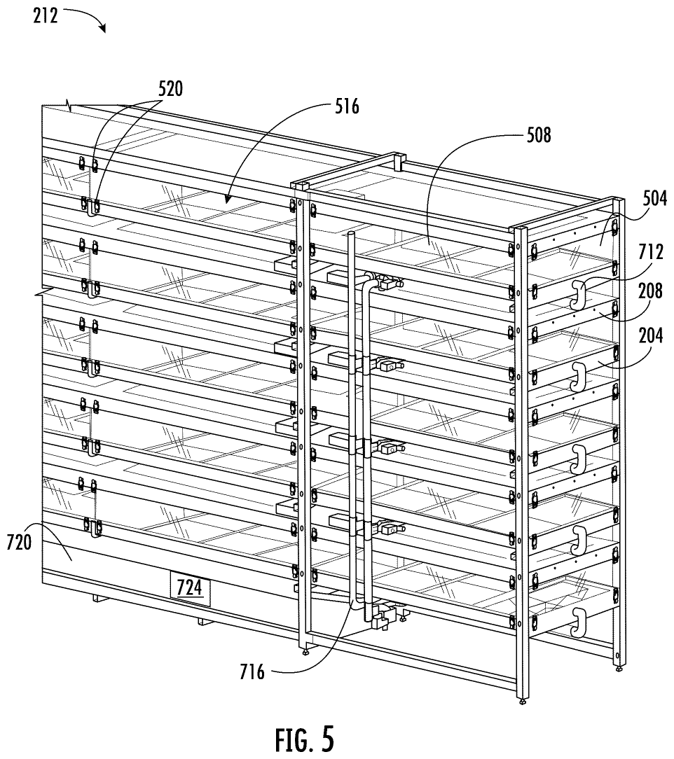

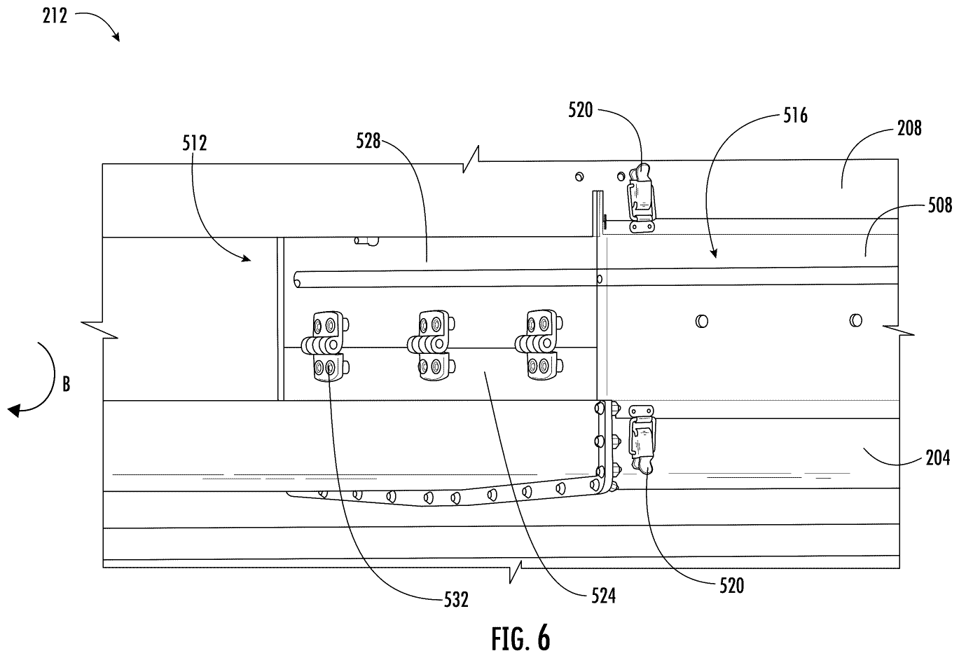

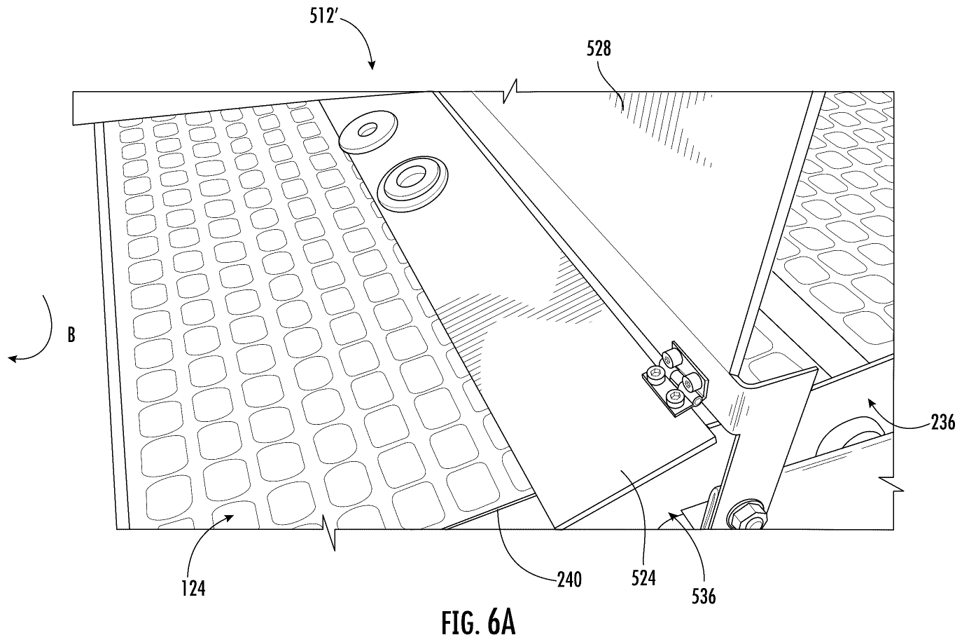

As shown in FIGS. 5-6, the germination portion 212 may include an entrance wall 504, first and second side walls 508, and an exit wall 512. The walls 504-512 may be coupled to the shelf 204 and the panel 208 in a substantially fluid-tight seal to enclose a volume therein 516 therebetween. This fluid-tight seal may capture vapor produced by evaporation of the mixture of water and nutrients from shelf 204 to provide humidity for the germinating seeds. The germination portion 212 may be sized to maintain a target humidity level within the enclosed volume 516. In some aspects, the germination portion 212 may include a humidity sensor configured to monitor a humidity level within the enclosed volume 516. In such aspects, the control system 120 may be communicatively coupled to the humidity sensor and configured to provide more water to the enclosed volume 516 in response to determining that a humidity level of the enclosed volume 516 is below a predefined threshold. In some aspects, the walls 504-512 may be removably coupled to the shelf 204 and the panel 208, for example by clips 520, which may allow the size of the germination portion 212 to be changed (e.g., by adding or removing side walls 508), for example to change a target humidity of the enclosed volume 516. In some aspects, the entrance wall 504 may be removed to place a seeded tray 124 in the germination portion 212. In some aspects, the walls 504-512 may be transparent to facilitate viewing of the seedlings therethrough. In some aspects, the walls 504-512 may be colored, which may protect the seeds and/or recently germinated seedlings that may be sensitive to light.

In some aspects, the exit wall 512 of the germination portion 212 may have a first portion 524 that may be movably coupled to a second portion 528, for example by hinges 532. In such aspects, the first portion 524 may be configured to pivot in the direction indicated by the arrow B relative to the second portion 528 to form an exit opening 536. As is described in greater detail below, the first portion 524 may be configured to pivot in the direction indicated by the arrow B when the first portion 524 is contacted by a first cart 236 holding a first tray 124 as a second cart holding a second tray is placed into the germination portion 212. The first portion 524 of the exit wall 512 may slide along the sides 240 of the first cart 236 as the first cart 236 and first tray 124 are passing through the exit opening 536. The side 240 of the cart 236 may prevent the first portion 524 of the exit wall 512 from contacting and/or damaging the seedlings as the cart 236 and tray 124 exit the germination portion 212.

FIG. 6A illustrates a variant of the exit wall 512′ of the germination portion 212 in which the exit wall 512′ of the germination portion 212 may be configured to pivot in the direction indicated by the arrow B form the exit opening 536. For example, the exit wall 512′ may be configured to pivot in the direction indicated by the arrow B when the exit wall 512′ is contacted by a first cart 236 holding a first tray 124 as a second cart holding a second tray is placed into the germination portion 212. The exit wall 512 may slide along the sides 240 of the first cart 236 as the first cart 236 and first tray 124 are passing through the exit opening 536. The side 240 of the cart 236 may prevent the exit wall 512′ from contacting and/or damaging the seedlings as the cart 236 and tray 124 exit the germination portion 212.

After exiting the germination portion 212, the tray 124 may enter the maturation portion 216. The tray 124 travels along the maturation portion 216 in the direction indicated by the arrow A as new trays 124 enter the enclosed volume 516 of the germination portion 212.

When the tray 124 reaches the end of maturation portion 216, the tray 124 is removed from the seedling germination and maturation system 108. In some aspects, the tray 124 may be transferred to the seedling packaging system 112. In some aspects, the seedling packaging system 112 may be an automated packaging system. In some aspects, the tray 124 is transferred to the seedling packaging system 112 by a machine. In some aspects, an operator may transfer the tray 124 to the seedling packaging system 112. In some embodiments, the tray 124 may travel from the seeding system 104 to the seedling germination and maturation system 108 to the seedling packaging system 112 without human intervention. In some aspects, the tray 124 may be packaged by the operator. In aspects in which the mature seedlings will be transplanted to a hydroponic growing system near the seedling gemination and maturation system 108, trays 124 of mature seedlings may be transported to the hydroponic growing system without being packaged.

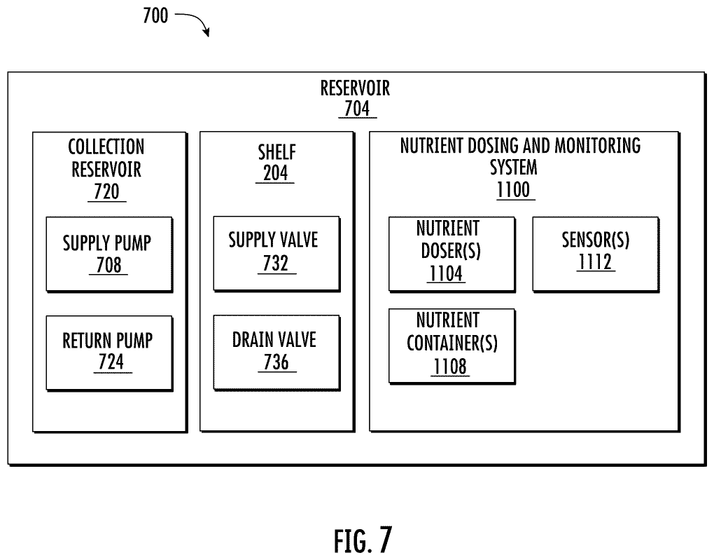

Referring now to FIGS. 5, 7, and 7A, the irrigation system 700 may include a reservoir 704, a supply pump 708, supply piping 712, drain piping 716, a collection reservoir 720, a return pump 724, and return piping (not shown). The irrigation system 700 may be configured to provide a mixture of water and nutrients to multiple seedling germination and maturation systems 108. The reservoir 704 may be configured to hold water and/or a mixture of water and nutrients to be delivered to the seeded trays 124 (e.g., via the shelves 204). In some aspects, the reservoir 704 may include an aerator. The reservoir 704 may be coupled to the supply piping 712, the return piping, and the pumps 708, 724. The supply pump 708 may be configured to pump the mixture of water and nutrients from the reservoir 704 into the supply piping 712. The reservoir 704 may be coupled to a water inlet configured to receive water from a water source, such as a municipal water supply, a well, and so forth. The reservoir 704 may also be coupled to a drain configured to drain water from the reservoir 704. The reservoir 704 may also be coupled to the return piping. The return pump 724 may be configured to pump water from the collection reservoir 720 to the reservoir 704 via the return piping. In some aspects, the irrigation system 700 may include both the reservoir 704 and the collection reservoir 720. In other aspects, the irrigation system 700 may only include the reservoir 704. In such aspects, the reservoir 704 includes the same functionalities as the reservoir 720. In some aspects, a volume of the collection reservoir 720 may be equal to at least the volume of the one of the shelves 204 for each of the seedling maturation and irrigation system 108 coupled to the irrigation system 700.

The supply piping 712 may have a first end coupled to the reservoir 704 and a second end coupled to each of the plurality of shelves 204. In other aspects, the supply piping 812 may be coupled to the reservoir 704 and/or the collection reservoir 720. The supply piping 712 may include a plurality of supply valves 732 (FIG. 7) moveable between a first position configured to allow fluid communication between the supply piping 712 and a particular one of the shelves 204 and a second position configured to prevent fluid communication between the supply piping 712 and the particular one of the shelves 204. In some aspects, the supply valves 732 may be ball valves. In some aspects, the supply valves 732 may be actuable by the controller 120 such that the controller 120 can open or close each of the supply valves 732. In such aspects, the controller 120 can open or close the supply valve(s) 732 for a particular shelf 204 independently of the supply valves 732 for the other shelves 204.

The supply pump 708 may be configured to pump water from the reservoir 704 into the shelves 204. For example, a particular supply valve 732 may be opened, and the supply pump 708 may pump water from the reservoir 704 into the particular shelf 204 to fill the shelf 204. The seedlings (and/or the growth media on the trays 124) may absorb a portion of the mixture of water and nutrients from the shelf 204. The mixture of water and nutrients may remain in the shelf 204 for a predefined period of time (e.g., dwell period).

The drain piping 716 may include a first end coupled to each of the plurality of shelves 204 and the collection reservoir 720. The drain piping 716 may include a plurality of drain valves 736 moveable between a first position configured to allow fluid communication between the drain piping 716 and a particular one of the shelves 204 and a second position configured to prevent fluid communication between the drain piping 716 and the particular one of the shelves 204. In some aspects, the drain valves 736 may be ball valves. In some aspects, the drain valves 736 may be actuable by the controller 120 such that the controller 120 can open or close each of the drain valves 736. In such aspects, the controller 120 can open or close the drain valve(s) 736 for a particular shelf 204 independently of the drain valves 736 for the other shelves 204.

After a predefined time period (e.g., dwell period) has elapsed, the particular drain valve 736 for the filled shelf 204 may be opened, allowing the mixture of water and nutrients to drain into the collection reservoir 720. In some aspects, the controller 120 may be configured to command the drain valve 736 to open after the predefined dwell period has elapsed. In some aspects, the controller 120 may be configured to control the supply valves 732 and the drain valves 736 for each of the shelves 204 independently of the supply and drain valves 732, 736 for the other shelves 204 such that the length of the dwell period for a particular shelf 204 can be independently controlled relative to the dwell period of the other shelves 204.

In some aspects, the control system 120 may be configured to operate the irrigation system 700 according to an ebb-and-flow irrigation protocol. In such aspects, an irrigation cycle may include commanding the supply valve 732 for a particular shelf 204 to open, pumping the mixture of water and nutrients into the particular shelf 204, closing the supply valve 732, maintaining the mixture of water and nutrients in the particular shelf 204 for a predefined dwell period, and then opening the drain valves 736 in the particular shelf 204 to drain the particular shelf 204. Similarly, in some aspects, the control system 120 may be configured to control a frequency of the irrigation cycles of each of the shelves 204 independently of the other shelves 204. As referred to herein, the term “a frequency of irrigation cycles” refers to how often the control system 120 commands the irrigation cycle to run.

The collection reservoir 720 may be configured to receive the mixture of water and nutrients that has drained from the shelves 204. The return pump 724 may be configured to pump the mixture of water and nutrients from the collection reservoir 720 to the reservoir 704 after the collection reservoir 720 has received a predefined volume of the mixture of water and nutrients. In some aspects, the return pump 724 may be a float-actuated pump that is configured to operate when an amount of the mixture of water and nutrients in the collection reservoir 720 exceeds a predefined threshold. The return pump 724 may be configured to pump the mixture of water and nutrients to the reservoir 704 along the return piping.

The control system 120 may be configured to monitor the components of the irrigation system 700 and send user notifications regarding the status of the components of the irrigation system 700. For example, in some aspects, the control system 120 may be configured to send pump failure notifications in response to determining that the supply pump 708 and/or the return pump 724 has failed. In some aspects, one or more depth sensors (not shown) may be coupled to the reservoir 704, the collection reservoir 720, the supply pump 708, and/or the return pump 724. The control system 120 may be configured to send a notification to a user in response to determining that the water level in the reservoir 704 and/or the collection reservoir 720 is below a predefined threshold. In some aspects, the predefined threshold is based on water level that can be safely pumped by the pumps 708, 724. In some aspects, the control system 120 may be configured to send a notification to an operator in response to determining that any of the shelves 204 is not filling and/or draining properly. In some aspects, the control system 120 may be configured to determine that any of the shelves 204 is not filling properly based on one or more of determining that the supply valve 732 is not working, the drain valve 736 is not working, determining, based on a water level sensor, that a predefined water level is not being maintained in the shelf 204, and so forth. In some aspects, the notifications may be displayed on a user interface of the control system 120. In other aspects, the notifications may be sent to a user device. In some aspects, audible notifications, indicator lights, and so forth may be used.

In some aspects, the seedling germination and maturation system 108 may be oriented in a first configuration in which the system 100 includes one seeding germination and maturation system 108. In such aspects, the system 100 may be oriented in a second configuration in which the system includes two or more seedling germination and maturation systems 108. In such aspects, the two or more seedling germination and maturation systems 108 may share features such as the collection reservoir 720, the reservoir 704, the return pump 724, the return piping 728, and nutrient dosing and monitoring system 1100. In aspects in which the system 100 is in the second configuration, the controller 120 controls of the seedling germination and maturation systems 108. In such aspects, the seedling germination and maturation systems 108 may be controlled independently of each other. In aspects in which the system 100 is in the second configuration, a user interface of the control system 120 may include separate monitoring windows for each of the seedling germination and maturation systems 108 controlled by the control system 120. In such aspects, the user interface may indicate the number of shelves 204 in each seedling germination and maturation system 108, seedlings grown in each particular shelf 204, recipes being used in each particular shelf 204 and/or in the lights 224, 228 overlying each of the shelves 204, image data captured by the cameras 232, and so forth.

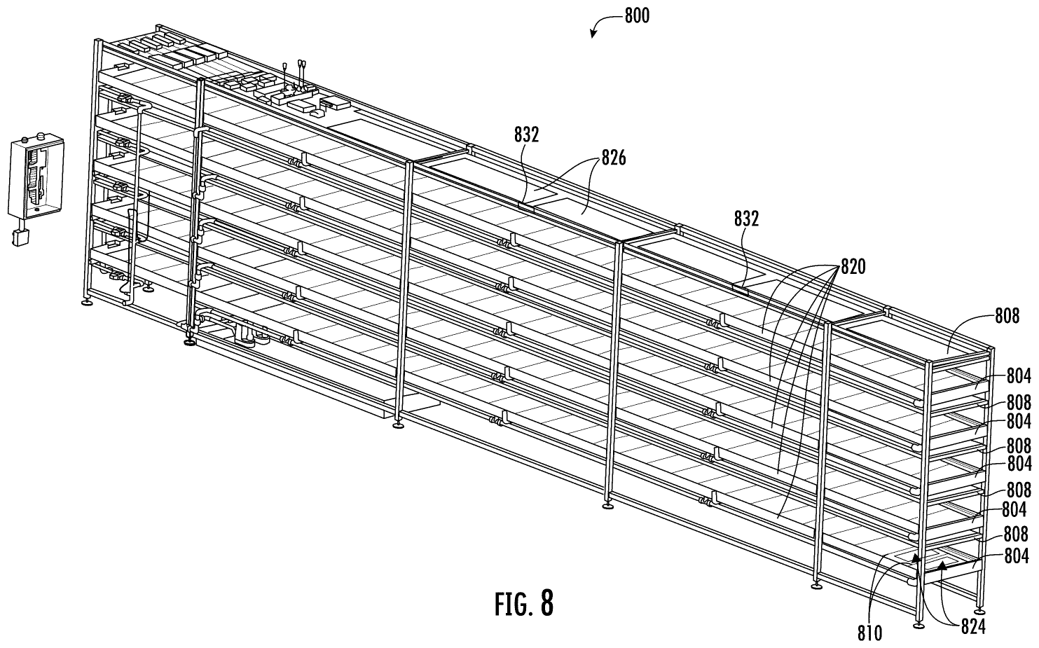

FIG. 8 illustrates a perspective view of an example seedling germination and maturation system 800 according to aspects of the present disclosure. In some aspects, the seedling germination and maturation system 800 may be used in the system 100 instead of the seedling germination and maturation system 108 described above. In other aspects, such as aspects in which the system 100 is deployed in the second configuration, the seedling germination and maturation system 800 may be used with the seedling germination and maturation system 108. Like numbering is used to indicate like parts between the seedling germination and maturation system 108 and the seedling germination and maturation system 800.

The seedling germination and maturation system 800 may include a plurality of shelves 804 and a plurality of panels 808. Each of the shelves 804 may include a plurality of struts 810 coupled between opposing sides 820 of the shelves 804. In some aspects, the struts 810 may be removably coupled to the opposing sides 820 of the shelves 804. The shelves 804 may be configured to support seeded trays 824 thereon. In some aspects, in the seedling germination and maturation system 800, the seeded trays 824 are positioned remain the shelves 804 and remain in the same position within the shelves 804 until the seedlings are mature enough for transplantation into a hydroponic growing system. The shelves 804 are configured to maintain the trays 824 as the seedlings mature. In some aspects, the shelves 804 may include rails similar to the rails 244 described. In such aspects, the tracks may be used to reposition the trays 824. In such aspects, the struts 810 may be removed prior to repositioning the trays 824.

The shelves 804 may be substantially tray-shaped (e.g., have raised sides 820) so that the shelves 804 may form an irrigation trough configured to each hold a mixture of water and nutrients therein. Each of the panels 208 may include groups (interchangeably referred to herein as pluralities) of lights 826 overlying portions of the shelves 804. Each of the groups of lights 826 may be independently controlled by the controller 120 based on the needs of the seeds/seedlings in the seeded trays 824 underlying the particular group of lights 826, as described in greater detail below.

In some aspects, a substantially fluid-tight enclosure may be coupled to portion(s) of the shelves that include trays 824 including seeds that have not yet germinated to form an enclosed volume similar to the enclosed volume 516. In such aspects, the humidity within the enclosed volume may be controlled as described with regard to the enclosed volume 516. In other aspects, substantially fluid-tight enclosures may be coupled to individual trays 824 including seeds that have not yet germinated.

In some aspects, the panels 808 may include one or more cameras 832. In some aspects, the cameras 832 may be a wide angle camera or an ultrawide angle camera. In some aspects, the cameras 832 may be configured to capture image data in the visual light spectrum, the infrared (IR) light spectrum, and/or both the visual light and IR light spectra. The one or more cameras 832 may be configured to capture images of the trays 824 and/or seedlings growing in the trays 824. For example, the cameras 832 may be coupled to the panels 808 facing the tray(s). In some aspects, cameras 832 may be mounted elsewhere. In some aspects, the cameras 832 may be configured to transmit the captured image data of the tray(s) and/or the seedlings to a display of a user input/output interface. In some aspects, the control system 120 may be configured to determine, based on the captured image data, that seedlings in a particular tray 124 have germinated, that the plant mass of seedlings in a particular tray 124 has increased, and/or that the seedlings in a particular tray 124 are mature and ready for transplantation. In some aspects, the control system 120 may be configured to alter a mixture of red and blue wavelengths of the light provided by the lights 826 based on the captured image data to change the growth of the seedlings. For example, light having red wavelengths may cause the seedlings to grow tall and thin, and light having blue wavelengths may cause the seedlings to grow short and wide.

In the variant shown in FIG. 8, the seedling germination and maturation system 800 may include five shelves 804. In other aspects, the seedling germination and maturation system 800 may include more or fewer shelves 804. In some aspects, a vertical spacing between adjacent shelves 804 may be customizable to accommodate seedlings of different heights.

When the seedlings in the seeded trays 824 are mature enough for transplantation into a hydroponic growing system, the tray 824 is removed from the seedling germination and maturation system 800. In some aspects, the control system 120 may determine that the seedlings in particular trays 824 are mature based on image data sent by the cameras 832. In other aspects, a human operator may determine that the seedlings in particular trays 824 are mature.

After the seedlings in a particular tray 824 have matured, the tray 824 is removed from the seedling germination and maturation system 800. In some aspects, the tray 824 may be transferred to the seedling packaging system 112. In some aspects, the seedling packaging system 112 may be an automated packaging system. In some aspects, the tray 824 is transferred to the seedling packaging system 112 by a machine. In some aspects, an operator may transfer the tray 824 to the seedling packaging system 112. In some aspects, the tray 824 may be packaged by the operator. In aspects in which the mature seedlings will be transplanted to a hydroponic growing system near the seedling gemination and maturation system 800, trays 824 of mature seedlings may be transported to the hydroponic growing system without being packaged.

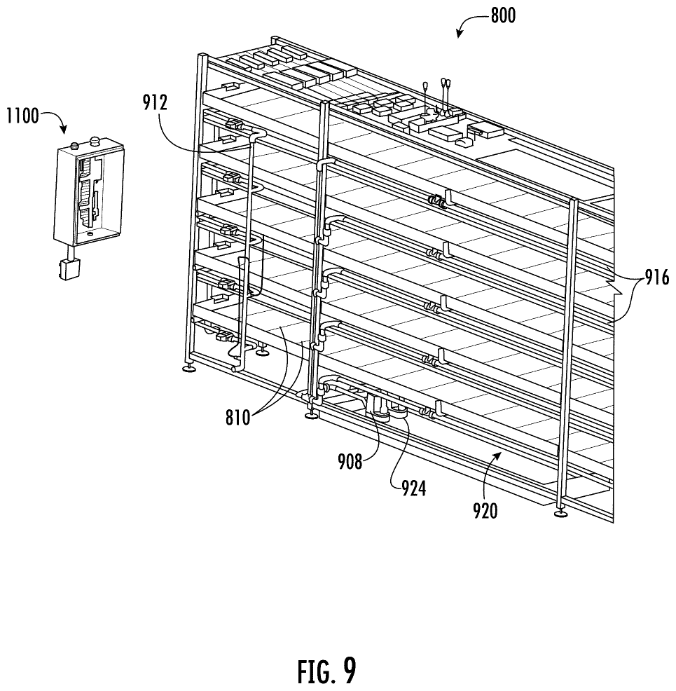

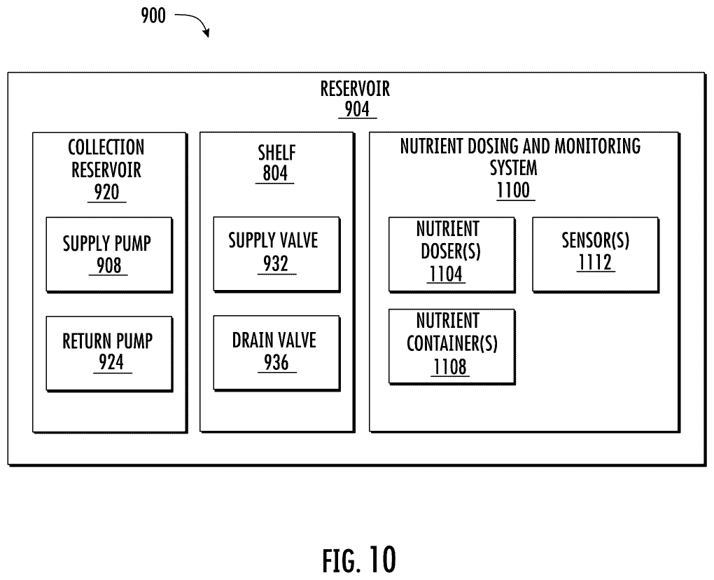

FIGS. 9 and 10 illustrate an example irrigation system 900. Like numbers are used to indicate like parts between the irrigation system 700 and the irrigation system 900. The irrigation system 700 may be configured to provide a mixture of water and nutrients to multiple seedling germination and maturation systems 800. The irrigation system 900 may include a reservoir 904, a supply pump 908, supply piping 912, drain piping 916, a collection reservoir 920, a return pump 924, and return piping (not shown) from the collection reservoir 920 to the reservoir 904. The reservoir 904 may be configured to hold water and/or a mixture of water and nutrients to be delivered to the seeded trays 824 (e.g., via the shelves 804). In some aspects, the reservoir 904 may include an aerator. The reservoir 904 may be coupled to the supply piping 912, the return piping, and the pumps 908, 921. In some aspects, the irrigation system 900 may include both the reservoir 904 and the collection reservoir 920. In other aspects, the irrigation system 900 may only include the reservoir 904. In such aspects, the reservoir 904 includes the same functionalities as the reservoir 920. In some aspects, a volume of the collection reservoir 920 may be equal to at least the volume of the one of the shelves 804 for each of the seedling maturation and irrigation system 108 coupled to the irrigation system 900.

The supply pump 908 may be configured to pump the mixture of water and nutrients from the reservoir 904 into the supply piping 912. The reservoir 904 may be coupled to a water inlet configured to receive water from a water source, such as a municipal water supply, a well, and so forth. The reservoir 904 may also be coupled to a drain configured to drain water from the reservoir 904. The reservoir 904 may also be coupled to the return piping. The return pump 924 may be configured to pump water from the collection reservoir 920 to the reservoir 904 via the return piping.

The supply piping 912 may have a first end coupled to the reservoir 904 and/or the collection reservoir 920 and a second end coupled to each of the plurality of shelves 204. The supply piping 912 may include a plurality of supply valves 932 (FIG. 10) moveable between a first position configured to allow fluid communication between the supply piping 912 and a particular one of the shelves 804 and a second position configured to prevent fluid communication between the supply piping 912 and the particular one of the shelves 804. In some aspects, the supply valves 932 may be ball valves. In some aspects, the supply valves 932 may be actuable by the control system 120 such that the control system 120 can open or close each of the supply valves 1032. In such aspects, the control system 120 can open or close the supply valve(s) 932 for a particular shelf 804 independently of the supply valves 932 for the other shelves 804.

The supply pump 908 may be configured to pump water from the reservoir 904 or the collection reservoir 920 into the shelves 804. For example, a particular supply valve 932 may be opened, and the supply pump 908 may pump water from the reservoir 904 or the collection reservoir 920 into the particular shelf 804 to fill the shelf 804. The seedlings (and/or the growth media on the trays 124) may absorb a portion of the mixture of water and nutrients from the shelf 804. The mixture of water and nutrients may remain in the shelf 804 for a predefined period of time (e.g. dwell period).

The drain piping 916 may include a first end coupled to each of the plurality of shelves 804 and the collection reservoir 920. The drain piping 916 may include a plurality of drain valves 936 (FIG. 10) moveable between a first position configured to allow fluid communication between the drain piping 916 and a particular one of the shelves 804 and a second position configured to prevent fluid communication between the drain piping 916 and the particular one of the shelves 804. In some aspects, the drain valves 936 may be ball valves. In some aspects, the drain valves 936 may be actuable by the controller 120 such that the controller 120 can open or close each of the drain valves 936. In such aspects, the controller 120 can open or close the drain valve(s) 936 for a particular shelf 804 independently of the drain valves 936 for the other shelves 804.

After a predefined time period (e.g., dwell period) has elapsed, the particular drain valve 936 for the filled shelf 804 may be opened, allowing the mixture of water and nutrients to drain into the collection reservoir 920. In some aspects, the controller 120 may be configured to command the drain valve 936 to open after the predefined dwell period has elapsed. In some aspects, the controller 120 may be configured to control the supply valves 932 and the drain valves 936 for each of the shelves 804 independently of the supply and drain valves 932, 936 for the other shelves 804 such that the length of the dwell period for a particular shelf 804 can be independently controlled relative to the dwell period of the other shelves 804. Similarly, in some aspects, the controller 120 may be configured to control a frequency of irrigation of each of the shelves 804 independently of the other shelves 804.

The collection reservoir 920 may be configured to receive the mixture of water and nutrients that has drained from the shelves 804. The return pump 924 may be configured to pump the mixture of water and nutrients from the collection reservoir 920 to the reservoir 904 after the collection reservoir 920 has received a predefined volume of the mixture of water and nutrients. In some aspects, the return pump 924 may be a float-actuated pump that is configured to operate when an amount of the mixture of water and nutrients in the collection reservoir 920 exceeds a predefined threshold. The return pump 924 may be configured to pump the mixture of water and nutrients to the reservoir 904 along the return piping.

In some aspects, the control system 120 may be configured to operate the irrigation system 900 according to an ebb-and-flow irrigation protocol. In such aspects, an irrigation cycle may include commanding the supply valve 932 for a particular shelf 804 to open, pumping the mixture of water and nutrients into the particular shelf 804, closing the supply valve 932, maintaining the mixture of water and nutrients in the particular shelf 804 for a predefined dwell period, and then opening the drain valves 936 in the particular shelf 804 to drain the particular shelf 804. Similarly, in some aspects, the controller 120 may be configured to control a frequency of the irrigation cycles of each of the shelves 804 independently of the other shelves 804.

In some aspects, the seedling germination and maturation system 800 may be oriented in a first configuration in which the system 100 includes one seeding germination and maturation system 800. In such aspects, the system 100 may be oriented in a second configuration in which the system includes two or more seedling germination and maturation systems 800. In such aspects, the two or more seedling germination and maturation systems 800 may share features such as the collection reservoir 920, the reservoir 904, the return pump 924, the return piping, and the nutrient dosing and monitoring system 1100. In aspects in which the system 100 is in the second configuration, the control system 120 controls of the seedling germination and maturation systems 800. In such aspects, the seedling germination and maturation systems 800 may be controlled independently of each other. In aspects in which the system 100 is in the second configuration, a user interface of the control system 120 may include separate monitoring windows for each of the seedling germination and maturation systems 108 controlled by the control system 120. In such aspects, the user interface may indicate the number of shelves 804 in each seedling germination and maturation system 108, seedlings grown in each particular shelf 804, recipes being used in each particular shelf 804 and/or in the particular groups of lights 826 overlying each of the shelves 804, image data captured by the cameras 832, and so forth.

The control system 120 may be configured to monitor the components of the irrigation system 900 and send user notifications regarding the status of the components of the irrigation system 900. For example, in some aspects is configured to send pump failure notifications in response to determining that the supply pump 908 and/or the return pump 924 has failed. In some aspects, one or more depth sensors (not shown) may be coupled to the reservoir 904, the collection reservoir 920, the supply pump 908, and/or the return pump 924. The control system 120 may be configured to send a notification to a user in response to determining that the water level in the reservoir 904 and/or the collection reservoir 920 is below a predefined threshold. In some aspects, the predefined threshold is based on water level that can be safely pumped by the pumps 908, 924. In some aspects, the control system 120 may be configured to send a notification to an operator in response to determining that any of the shelves 804 is not filling and/or draining properly. In some aspects, the control system 120 may be configured to determine that any of the shelves 804 is not filling properly based on one or more of determining that the supply valve 932 is not working, the drain valve 936 is not working, determining, based on a water level sensor, that a predefined water level is not being maintained in the shelf 804, and so forth. In some aspects, the notifications may be displayed on a user interface of the control system 120. In other aspects, the notifications may be sent to a user device. In some aspects, audible notifications, indicator lights, and so forth may be used.

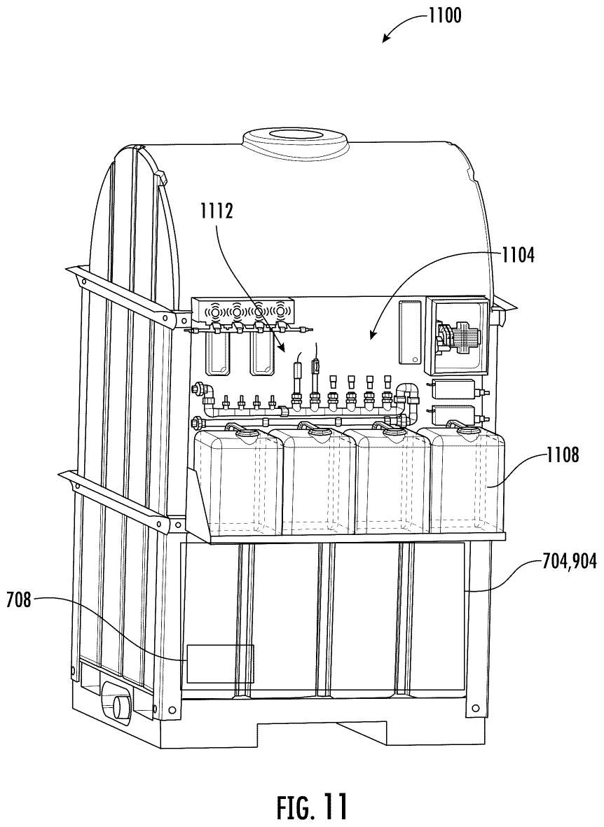

The nutrient dosing and monitoring system 1100 is shown in FIGS. 7, 10, and 11 in accordance with aspects of the present disclosure. The nutrient dosing and monitoring system 1100 can be used for the seedling germination and maturation system 108 and/or the seedling germination and maturation system 800. The nutrient dosing and monitoring system 1100 may include one or more nutrient dosers 1104, one or more nutrient containers 1108, and a plurality of sensors 1112. Each of the nutrient dosers 1104 may be coupled to one of the nutrient containers 1108 and be configured to dispense nutrients from the nutrient container 1108 into the mixture of water and nutrients in the reservoir 704, 1004. Example nutrients include nitrate, calcium, and/or phosphorus. In some aspects, one or more of the nutrient dosers 1104 and nutrient containers may include pH-adjusting agents.

The plurality of sensors 1112 may include at least a pH sensor, an electrical conductivity sensor, and a temperature sensor. The pH sensor may be configured to determine a pH of the mixture of water and nutrients in the reservoir 704, 1004 and transmit the determined pH to the control system 120. The electrical conductivity sensor may be configured to determine an electrical conductivity of the mixture of water and nutrients in the reservoir 704, 1004 and transmit the determined electrical conductivity to the control system 120. In some aspects, the sensed electrical conductivity may be indicative of an amount of nutrients in the mixture of water and nutrients in the reservoir 704, 1004. In some aspects, the plurality of sensors 1112 may include sensors configured to identify (e.g., distinguish among) electrical conductivities corresponding to particular types of ions, which correspond to particular nutrients. Such sensors may include a membrane that only allows a particular type of ion to pass through. The sensors may be configured to determine the electrical signal due the particular ion that can cross the membrane. Example ions may include nitrate, calcium, and phosphorus ions, among others.

The control system 120 may be communicatively coupled to the sensors 1112 and configured to issue a command to the dosers 1104 to adjust an amount of nutrients and/or other additives provided to the mixture of water and nutrients in the reservoir 704, 1004 based on information determined by the sensors 1112. For example, the control system 120 may receive the determined pH of the mixture of water and nutrients in the reservoir 704, 1004 and compare the determined pH to a predefined pH threshold. As used herein, the word “threshold” may refer to a single value or to a range of values. In response to determining that the determined pH falls outside of the predefined pH threshold, the control system 120 may issue a command to the dosers 1104 to add a pH adjusting additive to the reservoir 704, 1004. The control system 120 may receive the determined electrical conductivity of the mixture of water and nutrients in the reservoir 704, 1004 and compare the determined electrical conductivity to a predefined threshold. In response to determining that the electrical conductivity is below the predefined threshold, the control system 120 may issue a command to the dosers 1104 to add more nutrients to the reservoir 704, 1004. In some aspects, the nutrients may be added according to a predefined ratio. In aspects in which the controller 120 may receive determined electrical conductivities due to different types of ions, the control system 120 may compare the determined electrical conductivity due to each type of ion to a predefined threshold corresponding to that particular ion. In response to determining that the electrical conductivity for a particular ion is below the predefined threshold, the controller may issue a command to the dosers 1104 for a nutrient corresponding to that particular ion to add more of that particular nutrient to the reservoir 704, 1004.

In some aspects, the control system 120 may include (e.g., in the memory of the control system 120) or may be configured to access (e.g., from a networked device) a database of recipes. The database of recipes may include target thresholds of amounts of individual nutrients, target nutrient ratios, target pH thresholds, target irrigation dwell periods, target irrigation frequency rates, lighting cycles, target light wavelengths, target light intensities, target CO₂ levels, target humidity levels, and/or target air temperature set points. In some aspects, the recipes may be customized for a particular type of plant, groups of plants with similar nutritional needs, a phase in the lifecycle of the plant, and so forth. In some aspects, the recipes may be customized to deliver one or more particular characteristics, such a flavor profile, a color, a texture, and so forth for a particular type of plant. In such aspects, the control system 120 may be configured to issue a command to the dosers 1104 to provide nutrients to the reservoir 704, 1004 according to a particular recipe. In some aspects, the control system 120 may also be configured to issue a command to the dosers 1104 to maintain the pH of the mixture of water and nutrients in the reservoir 704, 1004 according to a particular recipe. In aspects in which recipes include target amounts of individual nutrients, target nutrient ratios, target pH thresholds, target irrigation dwell periods, target irrigation frequency rates, the recipe may be applied to all trays 124, 824 positioned within a particular shelf 204, 804.

In some aspects, the control system 120 may be configured to operate the lights 224, 228, 826 according to a predefined schedule, for example to mimic day and night. In some aspects, the control system 120 may be configured to control an amount and/or an intensity of light provided by the lights 224, 228, 826 based on a point in the lifecycle and/or a species of plant being grown in the trays 124, 824. For example, in some aspects, the control system 120 may be configured to control the lights 224, 228, 826 in response to determining that germination has occurred. In some aspects, the control system 120 may determine that germination has occurred, for example based on image data received by the cameras 232, 832. In other aspects, a human operator may determine that germination has occurred (either in the germination portion 212 or in particular tray(s) 824) and input the locations of the germinated trays 124, 824 to the control system 120. For example, some varieties of seeds may germinate better in the dark. When these varieties of seeds are in the trays 124, 824, the control system 120 may maintain the seeding germination portion 212 or the group of lights 826 above the portion of the shelves 804 including such seeds in darkness until a determination has been made that germination has occurred. When the trays 124, 824 include such seeds, the control system 120 may be configured to transmit a command to the lights 224, 228, 826 to turn the lights on for a predefined time interval (which may include up to 24 hour days) or to begin operating the lights 224, 228, 826 to mimic a night and day cycle in response to determining that germination has occurred. In some aspects, the control system 120 may be configured to transmit a command to the lights 224 of the germination portion 212 or the lights 826 overlying portions of the shelves 804 that include trays 824 having not yet or recently-germinated seeds to increase the brightness of the lights 224 in response to determining that seedlings germinated or have grown larger. In some aspects, the control system 120 may use machine learning methods to develop and/or refine methods for determining that germination has occurred, plant health, and so forth based on the captured image data. In some aspects, machine learning techniques may be used to optimize the amount of light, schedule of light, wavelength of light, and/or intensity of light provided to seedlings by the lights 224, 228, 826. In some aspects, the machine learning techniques may be used to optimize the amount of light, schedule of light, wavelength of light, and/or intensity of light provided to the seedlings (e.g., by the lights 224, 228, 826) based on germination state, seedling age, seedling size, seedling tyle, and so forth. The cameras 232, 832 may be operable to capture image data of the plants in the trays 124, 824 in the visual light spectrum, the infrared (IR) light spectrum, and/or both the visual light IR light spectra.

In aspects in which the database of recipes includes recipes customized for the lifecycle of the plant, the database of recipes may at least include recipes intended for seeds that have not yet germinated and germinated seedlings. Such recipes may include target irrigation dwell periods, target irrigation frequency rates, lighting cycles, target light wavelengths, target light intensities, target CO₂ levels, target humidity levels, and/or target air temperature set points. In such aspects, recipes for seedlings that have not yet germinated may specify that the lights in the germination portion 212 or the portion of lights 826 overlying trays 824 of seeds that have not yet germinated remain in the dark for 24 days. Recipes for seeds that have not yet germinated may include low irrigation frequencies. For example, the recipe may include instructions to only irrigate the trays 124, 824 once prior to determining that germination has occurred. Recipes for seedlings that have germinated may include 12-hour light/dark cycles, may include lights on for 24 hour days, or may include light/dark cycle with other lengths. Recipes for seedlings that have germinated may include instructions to increase an amount and/or an intensity of light for seedlings as they grow larger (e.g., based on data received from the cameras 232, 832, a length of time that has elapsed singe germination, and so forth). In some aspects, recipes for seedlings that have germinated may include instructions to modulate the wavelengths of the light provided to the seedlings to change the balance of red and blue wavelengths. In some aspects, the database of recipes may include recipes for seedlings that have germinated recently as well as recipes for more mature seedlings.

In some aspects, the controller 120 may be configured to maintain the tray 124 in the germination portion 212 for a predefined time period. For example, the controller 120 may be configured to prevent insertion of another tray 124 into the germination portion 212 prior to expiration of a predefined time period after a tray 124 has been inserted into the germination portion 212, prior to expiration of a predefined time period after germination has been detected, and so forth.

The climate control system 116 may be configured to measure and control humidity, carbon dioxide levels, temperature, and other related environmental factors. The climate control system 116 may include heating, ventilation, and air conditioning (HVAC) equipment that can include an air conditioner, dehumidifier, and/or a fan, among other climate control elements. The climate control system 116 may include a plurality of sensors, such as temperature sensors, humidity sensors, carbon dioxide (CO2) sensors, and so forth. The dehumidifier can remove the ambient moisture, condense the moisture, filter the condensed moisture and recycle the condensed moisture back into the farm's water supply. The dehumidifier can be stand-alone or integrated into the air conditioning unit.

In some aspects, details of various features that may be included in the seedling germination and maturation system 108 are shown and described in U.S. Pat. No. 10,271,486, entitled Insulated Shipping Containers Modified for High-Yield Plant Production Capable in Any Environment, filed Mar. 22, 2016, U.S. Patent Publication No. 2019/0133026 entitled Modular Farm Control and Monitoring System, which is the national phase application of a PCT application filed on Apr. 4, 2017, and/or U.S. Patent Application No. 17,546,333 entitled Systems and Methods for Controlling and Monitoring Farms, filed Dec. 9, 2021,all of which are incorporated herein by reference in relevant part.

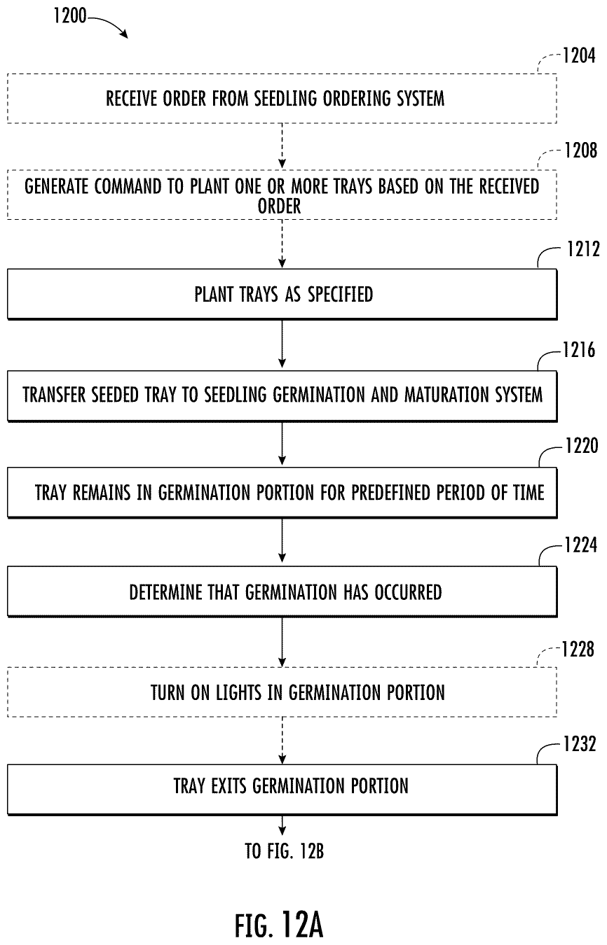

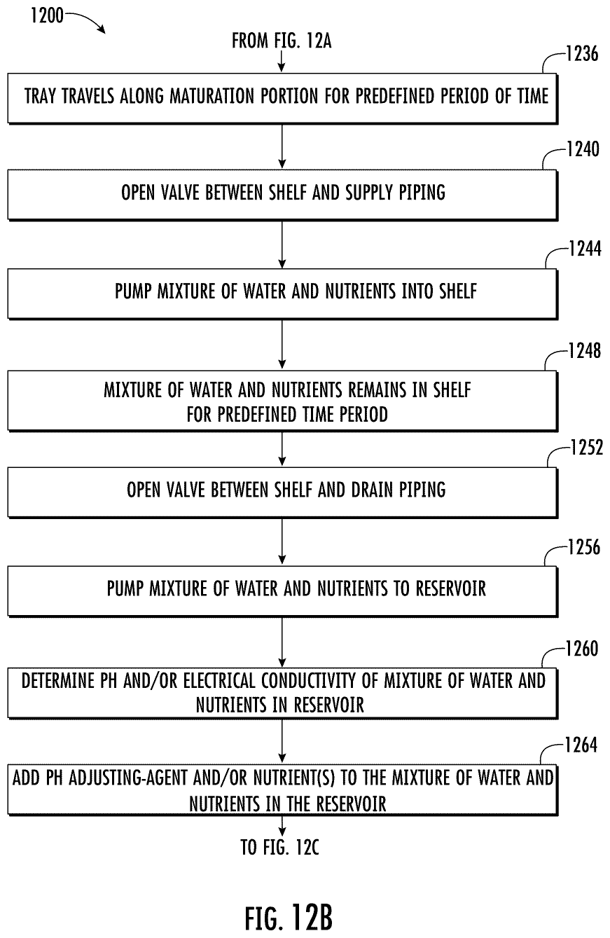

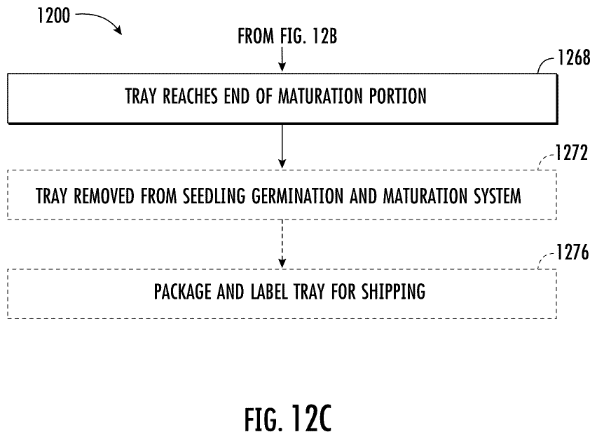

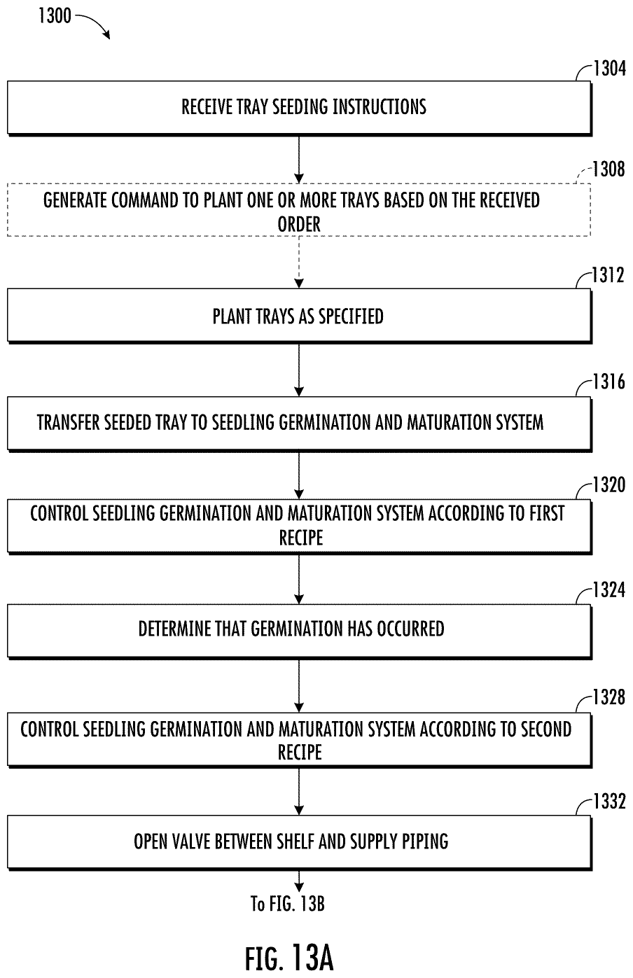

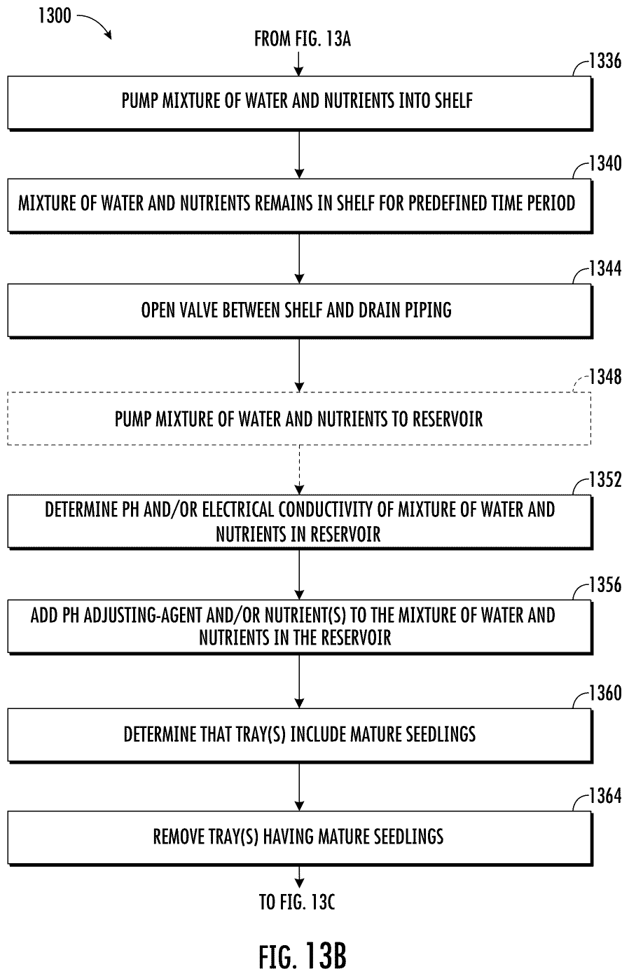

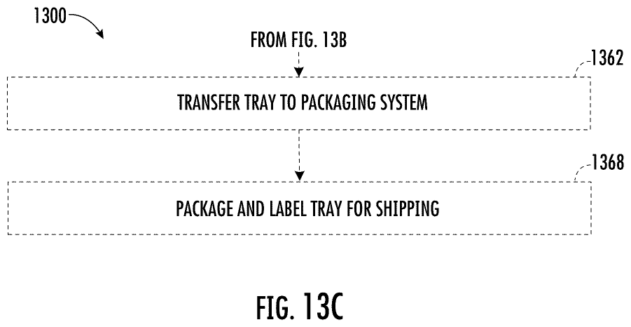

FIGS. 12A-12C illustrate an example method 1200 for providing seedlings to a user for transplantation into a hydroponic growing system. In some aspects, the method 1200 may be an entirely automated process. In other aspects, a portion of the method 1200 may be performed by a human operator or supervised by a human operator.

At 1204, the controller 120 may receive an order from a seedling ordering system 128. In some aspects, the seedling ordering system 128 may be a subset of a larger farm management system. The order may include a request for one or more desired varieties of seedlings.

At 1208, the controller 120 of the seeding system 104 may generate a command to plant one or more trays of seeds based on the received order. At 1212, the seeded trays are planted as specified in the received order. For example, in some aspects, the controller 120 may transmit the command to the seeding system 104 and the seeding system 104 plants the tray(s) 124 specified in the command. In other aspects, the controller 120 may transmit the command to a human operator via a user device such as a mobile computing system, tablet, laptop computer, operator input/output interface of the system 100, and so forth. In some aspects, 1204 and 1208 may be optional, and a human operator may receive the seedling order via another method.

At 1216, the seeded tray 124 may be transferred to the seedling germination and maturation system 108. Transferring the seeded tray 124 to the seedling germination and maturation system 108 may include placing the seeded tray 124 on the cart 236. As the newly seeded tray 124 (and cart 236) enters the germination portion 212 of the seedling germination and maturation system 108, the newly seeded tray 124 and cart 326 contact a tray 124 (and cart 246) already in the germination portion 212 and urges the tray 124 and the cart 236 already in the germination portion 212 in the direction indicated by the arrow A in FIG. 2 until the tray 124 is fully inside the germination portion 212. In some aspects, tray 124 may be transferred to the seedling germination and maturation system 108 mechanically. In some aspects, human operators may transfer the tray 124 to the seedling germination and maturation system 108.

At 1220, the tray 124 may remain in the germination portion 212 for a predefined period of time. At 1224, the camera 232 may capture images of tray 124 and transmit the images of tray 124 to control system 120. At 1224, a determination is made that germination has occurred. In some aspects, the controller 120 may determine that germination has occurred based on the images of the tray 124. In other aspects, a human operator may determine that germination has occurred. In such aspects, the human operation may input this determination into a user interface of the control system 120. At 1228, the controller 120 may command the lights 224 to turn on or off, operate according to a predefined schedule, etc. The controller 120 may continue monitoring the germinated seedlings while the tray 124 is in the germination portion 212. In such aspects, the controller 120 may control (e.g., increase or decrease) the amount or intensity, and so forth, of the light provided to the germinated seedlings by the lights 224 in response to determining that the germinated seedlings have grown stronger.

At 1232, the tray 124 may be contacted by a subsequent tray 124 as the subsequent tray 124 enters the germination portion 212 of the seedling germination and maturation system 108. The tray 124 rolls down the shelf 204 in the direction indicated by the arrow A (FIG. 2). As the first cart 236 and the first tray 124 exit the germination portion 212, the sides 240 of the first cart 236 may contact the first portion 524 of the exit wall 512, causing the exit wall 512 to pivot in the direction indicated by the arrow B (FIG. 6). The first portion 524 of the exit wall 512 may travel along the sides 240 of the first cart 236 as the first cart 236 exits the germination portion 212, preventing damage to the seedlings planted in the tray 124.

At 1236, the tray 124 (and cart 236) travel along the maturation portion 216 of the seedling germination and maturation system 108 in the direction indicated by the arrow A for a predefined period of time.

At 1240, the supply valve 732 between the shelf 204 and the supply piping 712 may be opened. At 1244, the supply pump 708 may pump the mixture of water and nutrients from the reservoir 704 or collection reservoir 720 into the shelf 204, substantially filling the shelf 204. At 1248, the mixture of water and nutrients may remain in shelf 204 for a predefined time period (e.g., dwell time). The seedlings, the growth media in the trays 124, and/or the air in the enclosed volume 516 may absorb the mixture of water and nutrients during the predefined time period.

At 1252, after expiration of the predefined time period, the drain valve 736 between the shelf 204 and the drain piping 716 may open, and the mixture of water and nutrients may drain into the collection reservoir 720. In some aspects, 1240-1252 may be referred to as an “irrigation cycle.” In such aspects, the phrase “a frequency of irrigation cycles” refers to how often the control system 120 commands the irrigation cycle to run.

At 1256, the mixture of water and nutrients in the collection reservoir 720 reaches a predefined liquid level and/or a predefined volume. The return pump 724 pumps the mixture of water and nutrients from the collection reservoir 720 to the reservoir 704 along the return piping.

At 1260, the control system 120 may determine one or more of a pH and an electrical conductivity of the mixture of water and nutrients in the reservoir 704 via the plurality of sensors 1112. At 1264, the control system 120 may command one or more dosers 726 to add a pH adjusting agent and/or one or more nutrients to the mixture of water and nutrients in the reservoir 704.

In some aspects, 1216-1236, 1240-1256, and 1260-1264 may occur simultaneously with each other.

At 1268, the tray 124 (and cart 236) reach the end of the maturation portion 216. At 1272, the tray 124 (and cart 236) are removed from the seedling germination and maturation system 108 and the tray 124 is transferred to the seedling packaging system 112 or retrieved by an operator. In some aspects, the transfer of the tray 124 to the seedling packaging system 112 may be automated. In some aspects, a human operator may transfer the tray 124 to the seedling packaging system 112. In aspects in which the seedlings in the tray 124 will be transplanted into a hydroponic growing system near the system 100, the tray 124 may not be packaged.

At 1276, which is optional, the seedling packaging system 112 may package the tray 124 for shipping and may label the tray 124 in accordance with the information in the order received from the seedling ordering system. In some aspects, 1276 may be the first time that the system 100 requires an operator (e.g., human being) to handle the tray 124.

FIGS. 13A-13C illustrate an example method 1300 for providing seedlings to a user for transplantation into a hydroponic growing system. In some aspects, the method 1300 may be an entirely automated process. In other aspects, a portion of the method 1300 may be performed by a human operator or supervised by a human operator.

At 1304, the controller 120 may receive tray seeding instructions. For example, in some aspects, the controller 120 may receive an order from a seedling ordering system 128 or a farm management system. In some aspects, the seedling ordering system 128 may be a subset of a larger farm management system. The order may include a request for one or more desired varieties of seedlings. In some aspects, a human operator may receive tray seeding instructions.

At 1308, the controller 120 of the seeding system 104 may generate a command to plant one or more trays of seeds based on the received order. At 1312, the seeded trays are planted as specified in the command. For example, in some aspects, the controller 120 may transmit the command to the seeding system 104 and the seeding system 104 plants the tray(s) 824 specified in the command. In other aspects, the controller 120 may transmit the command to a human operator via a user device such as a mobile computing system, tablet, laptop computer, operator input/output interface of the system 100, and so forth. In some aspects, 1304 and 1308 may be optional, and a human operator may receive the seedling order via another method.

At 1316, the seeded tray 824 may be transferred to the seedling germination and maturation system 800. For example, the seeded tray 824 may be positioned in the shelf 804. In some aspects, a human operator may update the control system 120 to indicate that a newly planted tray 824 has been positioned at a particular location at the shelf 804. In aspects in which the transfer to the seedling germination and maturation system 800 is automated, the automated transfer system may update the control system 120 to indicate that a newly planted tray 824 has been positioned at a particular location at the shelf 804. In some aspects, the control system 120 may include a position database that includes information indicative of each particular tray at a particular in the shelves 804. Example information indicative of each particular tray may include a type of seed, a day the seeds were planted, particular recipes to use for the seeds, and so forth.

At 1320, the control system 120 may control the seedling germination and maturation system 800 according to a recipe for seedlings that have not get germinated (e.g., a first recipe). For example, the control system 120 may control the group of lights 826 overlying the tray 824 and/or the irrigation system 900 according to the first recipe.

At 1324, a determination is made that germination has occurred. For example, in some aspects, the camera 832 may capture images of tray 824 and transmit the images of tray 824 to control system 120. In some aspects, the control system 120 may determine that germination has occurred based on the images of the tray 824. In other aspects, a human operator may determine that germination has occurred. In some aspects, the human operator may input locations of the tray(s) 824 at which germination has occurred to the control system 120.

At 1328, the control system 120 may control the seedling germination and maturation system 800 according to a recipe for seedlings that have already germinated (e.g., a second recipe). For example, in accordance with the second recipe, the control system 120 may command the lights 224 to turn on or off, operate according to a predefined schedule, keep the lights turned on, and so forth. In such aspects, the controller 120 may control (e.g., increase or decrease) the amount or intensity, and so forth, of the light provided to the germinated seedlings by the lights 224 in response to determining that the germinated seedlings have grown stronger. The control system 120 may also control the irrigation system 900 in accordance with the second recipe.

At 1332, the supply valve 1032 between the shelf 804 and the supply piping 1012 may be opened. At 1336, the supply pump 908 may pump the mixture of water and nutrients from the reservoir 904 into the shelf 804, substantially filling the shelf 804. At 1340, the mixture of water and nutrients may remain in shelf 804 for a predefined time period (e.g., dwell time). The seedlings and/or the growth media in the trays 824 may absorb the mixture of water and nutrients during the predefined time period.

At 1344, after expiration of the predefined time period, the drain valve 1036 between the shelf 804 and the drain piping 1016 may open, and the mixture of water and nutrients may drain into the collection reservoir 1020. At 1348, which is optional, the mixture of water and nutrients in the collection reservoir 920 reaches a predefined liquid level and/or a predefined volume. The return pump 924 pumps the mixture of water and nutrients from the collection reservoir 1020 to the reservoir 904 along the return piping.

At 1352, the control system 120 may determine one or more of a pH and an electrical conductivity of the mixture of water and nutrients in the reservoir 904 via the plurality of sensors 1112. At 1356, the control system 120 may command one or more dosers 1104 to add a pH adjusting agent and/or one or more nutrients to the mixture of water and nutrients in the reservoir 904.

In some aspects, 1320-1328, 1332-1348, and 1352-1356 may occur simultaneously with each other.

At 1360, a determination is made that the seedlings in one or more particular tray(s) 824 are mature. In some aspects, the controller 120 may determine that particular tray(s) are mature based on data received from the cameras 832. In some aspects, the human operator may determine that the seedlings in the tray(s) 824 are mature. In such aspects, the human operator may input the data indicating the position of the tray(s) 824 having mature seedlings into the control system 120.

At 1362, the mature tray(s) 824 are removed from the seedling germination and maturation system 800. At 1366, which is optional, the tray 824 may be transferred to the seedling packaging system 112. In some aspects, the transfer of the tray 824 to the seedling packaging system 112 may be automated. In some aspects, a human operator may transfer the tray 824 to the seedling packaging system 112. In aspects in which the seedlings in the tray 824 will be transplanted into a hydroponic growing system near the system 100, the tray 824 may not be packaged.

At 1366, which is optional, the seedling packaging system 112 may package the tray 824 for shipping and may label the tray 124 in accordance with the information in the order received from the seedling ordering system. In some aspects, 1276 may be the first time that the system 100 requires an operator (e.g., human being) to handle the tray 124.

Germinating and growing seedlings using the seedling germination and maturation system 108 described herein provides improved germination and maturation of seedlings relative to prior art systems such as conventional greenhouses. For example, seedlings may germinate and/or mature faster in the seedling germination and maturation system 108 than in conventional greenhouses. In some aspects, using a 24 hour light cycle for germinated seedlings can reduce time to transplant by 30% relative to seedlings growing under 12 hour light/12 hour darkness cycles or natural outdoor day/night cycles.

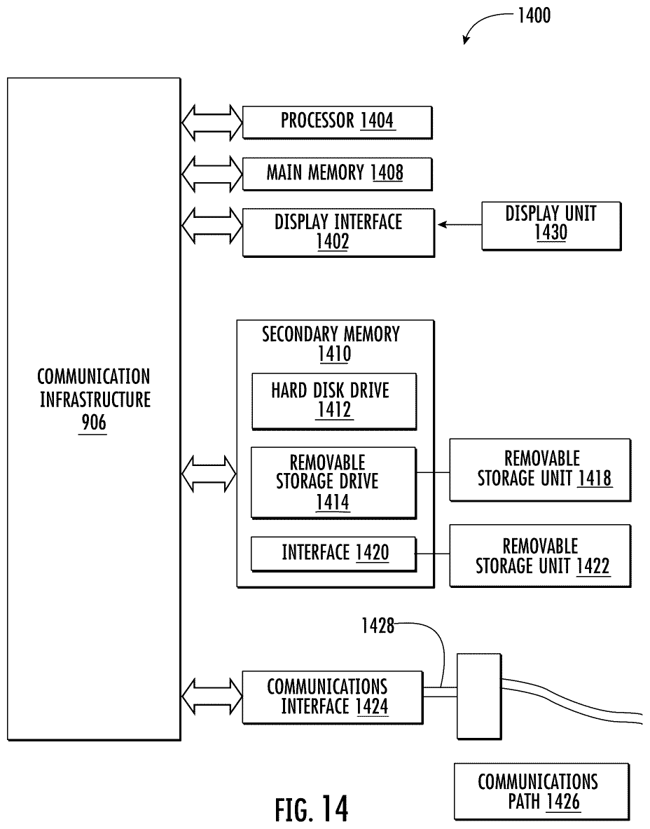

FIG. 14 presents an example system diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein of the system 100. An example of such a computer system 1400 is shown in FIG. 14.

The computer system 1400 includes one or more processors, such as processor 1404. The processor 1404 is connected to a communication infrastructure 1406 (e.g., a communications bus, cross-over bar, or network). The processor 1404 may include a processor for any of the local controllers 106, 110, 114 of FIG. 2. Various software aspects are described in terms of this example computer system. After reading this description, it will become apparent to a person skilled in the relevant art(s) how to implement aspects described herein using other computer systems and/or architectures.

Computer system 1400 may include a display interface 1402 that forwards graphics, text, and other data from the communication infrastructure 1406 (or from a frame buffer not shown) for display on a display unit 1430. Computer system 1400 also includes a main memory 1408, preferably random access memory (RAM), and may also include a secondary memory 1410. The secondary memory 1410 may include, for example, a hard disk drive 1412 and/or a removable storage drive 1414, representing a floppy disk drive, a magnetic tape drive, an optical disk drive, etc. The removable storage drive 1414 reads from and/or writes to a removable storage unit 1418 in a well-known manner. Removable storage unit 1418, represents a floppy disk, magnetic tape, optical disk, etc., which is read by and written to removable storage drive 1414. As will be appreciated, the removable storage unit 1418 includes a computer usable storage medium having stored therein computer software and/or data.

In alternative aspects, secondary memory 1410 may include other similar devices for allowing computer programs or other instructions to be loaded into computer system 1400. Such devices may include, for example, a removable storage unit 1422 and an interface 1420. Examples of such may include a program cartridge and cartridge interface (such as that found in video game devices), a removable memory chip (such as an erasable programmable read only memory (EPROM), or programmable read only memory (PROM)) and associated socket, and other removable storage units 1422 and interfaces 1420, which allow software and data to be transferred from the removable storage unit 1422 to computer system 1400. In an example, memory for the control system 120 may include the main memory 1408, the secondary memory 1410, the removable storage drive 1414, the removable storage unit 1418, the removable storage unit 1422, etc.

The computer system 1400 may also include a communications interface 1424. Communications interface 1424 allows software and data to be transferred between computer system 1400 and external devices. Examples of communications interface 1424 may include a modem, a network interface (such as an Ethernet card), a communications port, a Personal Computer Memory Card International Association (PCMCIA) slot and card, etc. Software and data transferred via communications interface 1424 are in the form of signals 1428, which may be electronic, electromagnetic, optical or other signals capable of being received by communications interface 1424. These signals 1428 are provided to communications interface 1424 via a communications path (e.g., channel) 1426. This path 1426 carries signals 1428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive, a hard disk installed in a hard disk drive, and/or signals 1428. These computer program products provide software to the computer system 1400. Aspects described herein may be directed to such computer program products.

Computer programs (also referred to as computer control logic) are stored in main memory 1408 and/or secondary memory 1410. Computer programs may also be received via communications interface 1424. Such computer programs, when executed, enable the computer system 1400 to perform various features in accordance with aspects described herein. In particular, the computer programs, when executed, enable the processor 1404 to perform such features. Accordingly, such computer programs represent controllers of the computer system 1400.

In variations where aspects described herein are implemented using software, the software may be stored in a computer program product and loaded into computer system 1400 using removable storage drive 1414, hard disk drive 1412, or communications interface 1420. The control logic (software), when executed by the processor 1404, causes the processor 1404 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

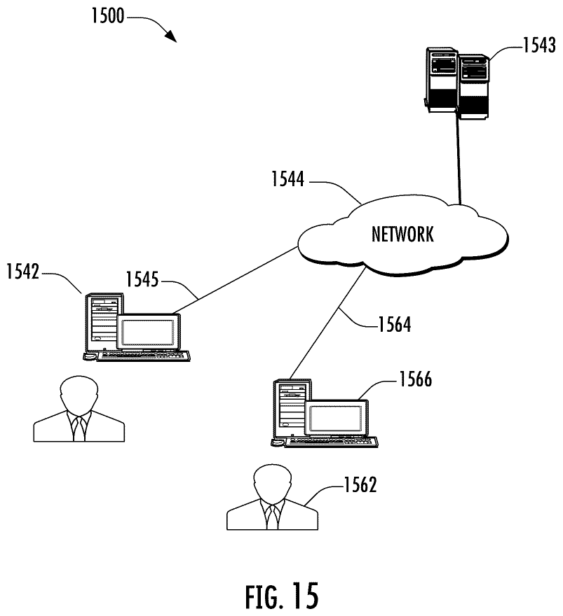

FIG. 15 is a block diagram of various example system components for use in accordance with aspects of the present disclosure. FIG. 15 shows a communication system 1500 usable in accordance with aspects described herein. The communication system 1500 may include one or more users 1560, 1562 and one or more terminals 1542, 1566. For example, terminals 1542, 1566 may include the control system 120 or a related system, and/or the like. In one aspect, data for use in accordance with aspects described herein is, for example, input and/or accessed by users 1560, 1562 via terminals 1542, 1566, such as personal computers (PCs), minicomputers, mainframe computers, microcomputers, telephonic devices, or wireless devices, such as personal digital assistants (“PDAs”) or a hand-held wireless devices coupled to a server 1543, such as a PC, minicomputer, mainframe computer, microcomputer, or other device having a processor and a repository for data and/or connection to a repository for data, via, for example, a network 1544, such as the Internet or an intranet, and couplings 1545, 1546, 1564. The couplings 1545, 1546, 1564 include, for example, wired, wireless, or fiberoptic links. In another example variation, the method and system in accordance with aspects described herein operate in a stand-alone environment, such as on a single terminal.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The present disclosure may include aspects according to one or more of the following clauses.

Clause 1. A seedling germination and maturation system comprising: a reservoir; a pump in fluid communication with the reservoir; a plurality of shelves, wherein each of the plurality of shelves includes: raised side walls configured to form an irrigation trough configured to receive a plurality of seeded trays; a supply valve in fluid communication with the irrigation trough and a pump outlet; a drain valve in fluid communication with the irrigation trough and the reservoir; and a controller configured to actuate the pump and, for a particular shelf of the plurality of shelves, acuate the particular fill valve and the particular drain valve of the particular shelf, to control an irrigation cycle for each particular shelf of the plurality of shelves, wherein the irrigation cycle for each particular shelf is controlled independently of the irrigation cycles for other shelves of the plurality of shelves.

Clause 2. The seedling germination and maturation system of clause 1, wherein controlling the irrigation cycle of a particular shelf includes opening a fill valve in a particular shelf of the plurality of shelves and actuating the pump to fill the irrigation trough of the particular shelf.

Clause 3. The seedling germination and maturation system of clause 1, wherein controlling the irrigation cycle of a particular shelf includes opening the drain valve in the particular shelf to drain the particular shelf after expiration of a dwell period.

Clause 4. The seedling germination and maturation system of clause 1, wherein the controller is configured to control the irrigation cycle for each particular shelf according to a first irrigation recipe after a determination has been made that germination has not yet occurred and a second irrigation recipe after a determination has been made that germination has occurred.

Clause 5. The seedling germination and maturation system of clause 1, further comprising a lighting system configured to provide light to the plurality of shelves, and wherein the controller is configured to control lighting for each particular shelf according to a first lighting recipe before a determination has been made that germination has occurred and a second lighting recipe after a determination has been made that germination has occurred.

Clause 6. The seedling germination and maturation system of clause 1, further comprising at least one camera configured to receive image data of one or more seeded trays positioned in the plurality of shelves, and wherein the controller is configured to: receive captured image data from the at least one camera; and determine, based on the captured image data, that germination has occurred in a seeded tray positioned in the plurality of shelves.

Clause 7. The seedling germination and maturation system of clause 1, wherein the plurality of shelves are configured to receive seeded trays that are configured to produce seedling plugs mature enough for transplantation into a hydroponic plant growing system.

Clause 8. The seedling germination and maturation system of clause 7, wherein the seedling germination and maturation system is configured to support the seeded trays as the seedlings within the seeded trays grow from ungerminated seeds to seedings mature enough for transplantation into the hydroponic plant growing system.

Clause 9. The seedling germination and maturation system of clause 1, wherein the plurality of shelves is configured to be deployed in a first configuration or a second configuration, and wherein the controller is configured to display a first graphical user interface (GUI) when the plurality of shelves is deployed in the first configuration and a second GUI when the plurality of shelves is deployed in the second configuration.

Clause 10. The seedling germination and maturation system of clause 1, wherein the controller is remotely located from the seedling germination and maturation system.

Clause 11. The seedling germination and maturation system of clause 1, wherein the controller is configured to control two or more seedling germination and maturation systems.

Clause 12. A seedling production system comprising: a seedling germination and maturation system comprising a plurality of shelves configured to receive a plurality of seeded trays therein, wherein each of the plurality of shelves includes: a seedling germination portion configured to receive plurality of seeded trays at least until a determination has been made that germination has occurred, wherein the seedling germination portion includes a plurality of walls couplable to each of the plurality of shelves to form a germination volume and maintain the germination volume at a target humidity range; and a seedling maturation portion configured to receive the plurality of seeded trays for a maturation period after the plurality of seeded trays have exited the seedling germination portion.

Clause 13. The seedling production system of clause 12, further comprising at least one camera configured to receive image data of the seedling germination portion, and a controller comprising a processor and a memory, the memory including computer-executable instructions executable by the processor configured to: receive captured image data from the at least one camera; and determine, based on the captured image data, that germination has occurred in the plurality of seeded trays.

Clause 14. The seedling production system of clause 13, further comprising a lighting system configured to provide light to the seedling germination portion, and wherein the controller is configured to command the lighting system to increase an amount of light provided to the seedling germination portion in response to determining that germination has occurred in the plurality of seeded trays.

Clause 15. The seedling production system of clause 14, wherein increasing the amount of light provided to the seedling germination portion includes turning on one or more lights in the lighting system.

Clause 16. The seedling production system of clause 14, wherein the captured image data is first captured image data, and wherein controller is configured to: receive second captured image data; determine, based on the second captured image data, that the seedlings growing in the plurality of seeded trays have grown; and command a lighting system coupled to the seedling germination portion to increase an intensity of light provided to the plurality of seeded trays.

Clause 17. The seedling production system of clause 12, further comprising: a seeding system configured to plant seeds in a plurality of trays; and a controller comprising a processor and a memory, the memory including computer-executable instructions executable by the processor configured to: receive a seedling order; and generate a seeding command based on the seedling order, the seeding command including one or more of an amount of seeded trays to produce, a type of seeds to plant in the seeded trays, a density of seeds to plant, or a combination thereof.

Clause 18. The seedling production system of clause 12, further comprising: a seedling packaging system configured to receive and package seeded trays exiting the seedling maturation portion.

Clause 19. The seedling production system of clause 12, wherein the plurality of walls are removably coupled to the plurality of shelves.

Clause 20. The seedling production system of clause 12, wherein one of the walls of the plurality of walls is positioned between the seedling germination portion and the seedling maturation portion and includes a movable portion configured to open when contacted by a tray of the plurality of seeded trays as the tray moves from the seedling germination portion to the seedling maturation portion.

Clause 21. The seedling production system of clause 12, further comprising a controller comprising a processor and a memory, the memory including computer-executable instructions executable by the processor configured to: determine that a predefined time interval has elapsed since a first seeded tray of the plurality of seeded trays was added to the seedling germination portion; and cause a second seeded tray of the plurality of seeded trays to be added to the seedling germination portion.

Clause 22. A computer-implemented method for providing one or more seedlings to a farm, the computer-implemented method comprising: receiving captured image data of one or more seeded trays positioned in a germination portion of a seedling germination and maturation system; determining, based on the captured image data, that germination has occurred in the one or more seeded trays; and increasing an amount of light provided to the one or more seeded trays in response to determining that germination has occurred.

Clause 23. The computer-implemented method of clause 22, further comprising: receiving a seedling order; determining seeding instructions based on the seedling order, the seeding instructions including a number of seeds to plant, a type of seeds to plant, a density of seeds to plant, or a combination thereof; and commanding a seeding machine to seed one or more trays based on the seeding instructions.

Clause 24. The computer-implemented method of clause 22, wherein the captured image data is first captured image data, and wherein the computer-implemented method includes: receiving second captured image data; determining, based on the second captured image data, that the seedlings growing in the plurality of seeded trays have grown; and commanding a lighting system coupled to the seedling germination portion to increase an intensity of light provided to the plurality of seeded trays.

Clause 25. The computer-implemented method of clause 22, wherein the computer-implemented method includes: determining that a predefined time interval has elapsed since a first seeded tray of the plurality of seeded trays was added to the seedling germination portion; and causing a second seeded tray of the plurality of seeded trays to be added to the seedling germination portion.

Clause 26. The computer-implemented method of clause 25, wherein causing a second seeded tray of the plurality of seeded trays to be added to the seedling germination portion includes commanding a transfer device to add the second seeded tray of the plurality of seeded trays to the seedling germination portion.

Clause 27. The computer-implemented method of clause 22, wherein the computer-implemented method includes: determining that a predefined time interval has elapsed since a first seeded tray of the plurality of seeded trays was added to the seedling germination portion; and causing a second seeded tray of the plurality of seeded trays to be removed from a seedling maturation portion of the seedling germination and maturation system, wherein the second seeded tray includes mature seedlings.

Clause 28. The computer-implemented method of clause 27, wherein causing a second seeded tray of the plurality of seeded trays to be removed from a seedling maturation portion of the seedling germination and maturation system includes commanding a transfer device to remove the second seeded tray of the plurality of seeded trays from to the seedling maturation portion.

1. A seedling germination and maturation system comprising:
a reservoir;
a pump in fluid communication with the reservoir;
a plurality of shelves, wherein each of the plurality of shelves includes:
raised side walls configured to form an irrigation trough configured to receive a plurality of seeded trays;
a supply valve in fluid communication with the irrigation trough and a pump outlet;
a drain valve in fluid communication with the irrigation trough and the reservoir; and
a controller configured to actuate the pump and, for a particular shelf of the plurality of shelves, acuate the particular fill valve and the particular drain valve of the particular shelf, to control an irrigation cycle for each particular shelf of the plurality of shelves, wherein the irrigation cycle for each particular shelf is controlled independently of the irrigation cycles for other shelves of the plurality of shelves.

2. The seedling germination and maturation system of claim 1, wherein controlling the irrigation cycle of a particular shelf includes opening a fill valve in a particular shelf of the plurality of shelves and actuating the pump to fill the irrigation trough of the particular shelf.

3. The seedling germination and maturation system of claim 1, wherein controlling the irrigation cycle of a particular shelf includes opening the drain valve in the particular shelf to drain the particular shelf after expiration of a dwell period.

4. The seedling germination and maturation system of claim 1, wherein the controller is configured to control the irrigation cycle for each particular shelf according to a first irrigation recipe after a determination has been made that germination has not yet occurred and a second irrigation recipe after a determination has been made that germination has occurred.

5. The seedling germination and maturation system of claim 1, further comprising a lighting system configured to provide light to the plurality of shelves, and wherein the controller is configured to control lighting for each particular shelf according to a first lighting recipe before a determination has been made that germination has occurred and a second lighting recipe after a determination has been made that germination has occurred.

6. The seedling germination and maturation system of claim 1, further comprising at least one camera configured to receive image data of one or more seeded trays positioned in the plurality of shelves, and wherein the controller is configured to:
receive captured image data from the at least one camera; and
determine, based on the captured image data, that germination has occurred in a seeded tray positioned in the plurality of shelves.

7. The seedling germination and maturation system of claim 1, wherein the plurality of shelves are configured to receive seeded trays that are configured to produce seedling plugs mature enough for transplantation into a hydroponic plant growing system.

8. The seedling germination and maturation system of claim 7, wherein the seedling germination and maturation system is configured to support the seeded trays as the seedlings within the seeded trays grow from ungerminated seeds to seedings mature enough for transplantation into the hydroponic plant growing system.

9. The seedling germination and maturation system of claim 1, wherein the plurality of shelves is configured to be deployed in a first configuration or a second configuration, and wherein the controller is configured to display a first graphical user interface (GUI) when the plurality of shelves is deployed in the first configuration and a second GUI when the plurality of shelves is deployed in the second configuration.

10-11. (canceled)

12. A seedling production system comprising:
a seedling germination and maturation system comprising a plurality of shelves configured to receive a plurality of seeded trays therein, wherein each of the plurality of shelves includes:
a seedling germination portion configured to receive plurality of seeded trays at least until a determination has been made that germination has occurred, wherein the seedling germination portion includes a plurality of walls couplable to each of the plurality of shelves to form a germination volume and maintain the germination volume at a target humidity range; and
a seedling maturation portion configured to receive the plurality of seeded trays for a maturation period after the plurality of seeded trays have exited the seedling germination portion.

13. The seedling production system of claim 12, further comprising at least one camera configured to receive image data of the seedling germination portion, and a controller comprising a processor and a memory, the memory including computer-executable instructions executable by the processor configured to:
receive captured image data from the at least one camera; and
determine, based on the captured image data, that germination has occurred in the plurality of seeded trays.

14. The seedling production system of claim 13, further comprising a lighting system configured to provide light to the seedling germination portion, and wherein the controller is configured to command the lighting system to increase an amount of light provided to the seedling germination portion in response to determining that germination has occurred in the plurality of seeded trays.

15. (canceled)

16. The seedling production system of claim 14, wherein the captured image data is first captured image data, and wherein controller is configured to:
receive second captured image data;
determine, based on the second captured image data, that the seedlings growing in the plurality of seeded trays have grown; and
command a lighting system coupled to the seedling germination portion to increase an intensity of light provided to the plurality of seeded trays.

17. The seedling production system of claim 12, further comprising:
a seeding system configured to plant seeds in a plurality of trays; and
a controller comprising a processor and a memory, the memory including computer-executable instructions executable by the processor configured to:
receive a seedling order; and
generate a seeding command based on the seedling order, the seeding command including one or more of an amount of seeded trays to produce, a type of seeds to plant in the seeded trays, a density of seeds to plant, or a combination thereof.

18. (canceled)

19. The seedling production system of claim 12, wherein the plurality of walls are removably coupled to the plurality of shelves.

20. The seedling production system of claim 12, wherein one of the walls of the plurality of walls is positioned between the seedling germination portion and the seedling maturation portion and includes a movable portion configured to open when contacted by a tray of the plurality of seeded trays as the tray moves from the seedling germination portion to the seedling maturation portion.

21. The seedling production system of claim 12, further comprising a controller comprising a processor and a memory, the memory including computer-executable instructions executable by the processor configured to:
determine that a predefined time interval has elapsed since a first seeded tray of the plurality of seeded trays was added to the seedling germination portion; and
cause a second seeded tray of the plurality of seeded trays to be added to the seedling germination portion.

22. A computer-implemented method for providing one or more seedlings to a farm, the computer-implemented method comprising:
receiving captured image data of one or more seeded trays positioned in a germination portion of a seedling germination and maturation system;
determining, based on the captured image data, that germination has occurred in the one or more seeded trays; and
increasing an amount of light provided to the one or more seeded trays in response to determining that germination has occurred.

23. The computer-implemented method of claim 22, further comprising:
receiving a seedling order;
determining seeding instructions based on the seedling order, the seeding instructions including a number of seeds to plant, a type of seeds to plant, a density of seeds to plant, or a combination thereof; and
commanding a seeding machine to seed one or more trays based on the seeding instructions.

24. The computer-implemented method of claim 22, wherein the captured image data is first captured image data, and wherein the computer-implemented method includes:
receiving second captured image data;
determining, based on the second captured image data, that the seedlings growing in the plurality of seeded trays have grown; and
commanding a lighting system coupled to the seedling germination portion to increase an intensity of light provided to the plurality of seeded trays.

25-28. (canceled)
